(19) United States
(12) Patent Application Publication
(10) Pub. No.: US 2025/0109995 A1
(43) Pub. Date: Apr. 3, 2025

(54) LOAD DETECTING DEVICE

(71) Applicant: Panasonic Intellectual Property Management Co., Ltd., Osaka (JP)

(72) Inventors: Takafumi HAMANO, Fukuoka (JP); Hiroyuki FURUYA, Osaka (JP); Yuta MORIURA, Osaka (JP); Susumu URAGAMI, Kumamoto (JP); Takashi MATSUMOTO, Osaka (JP); Yodai MATSUMURA, Osaka (JP)

(21) Appl. No.: 18/979,930

(22) Filed: Dec. 13, 2024

Related U.S. Application Data
(63) Continuation of application No. PCT/JP2023/021154, filed on Jun. 7, 2023.

(30) Foreign Application Priority Data
Jun. 23, 2022 (JP) 2022-101273

(51) Int. Cl. G01L 1/14

(52) U.S. Cl. CPC G01L 1/142

(57) ABSTRACT

A load detecting device includes a load sensor and a sealing member encapsulating the load sensor. The sealing member includes a lower sealing member on which the load sensor is placed, an upper sealing member covering an upper face of the load sensor and joined to the lower sealing member, and an air pressure adjustment structure configured to cause an air pressure in an accommodation space, of the load sensor, formed by the lower sealing member and the upper sealing member to be approximately equal to an outside air pressure.

### CROSS REFERENCE TO RELATED APPLICATION

This application is a continuation of International Application No. PCT/JP2023/021154 filed on Jun. 7, 2023, entitled “LOAD DETECTING DEVICE”, which claims priority under 35 U.S.C. Section 119 of Japanese Patent Application No. 2022-101273 filed on Jun. 23, 2022, entitled “LOAD DETECTING DEVICE”. The disclosures of the above applications are incorporated herein by reference.

### BACKGROUND OF THE INVENTION

### Field of the Invention

The present invention relates to a load detecting device that detects a load applied from outside, based on change in capacitance.

### Description of Related Art

Load detecting devices are widely used in the fields of industrial apparatuses, robots, vehicles, and the like. In recent years, in accordance with advancement of control technologies by computers and improvement of design, development of electronic apparatuses that use a variety of free-form surfaces such as those in human-form robots and interior equipment of automobiles is in progress. In association therewith, it is required to mount a high performance load sensor to each free-form surface.

International Publication No. WO2018/096901 describes a capacitance-type load sensor that includes: a first electrically-conductive member having elasticity; and a second electrically-conductive member having a linear shape and covered by a dielectric body. In this load sensor, due to application of a load, the contact area between the first electrically-conductive member and the dielectric body increases, and the capacitance between the first electrically-conductive member and the second electrically-conductive member changes. Based on this change in capacitance, the load applied to the load sensor is detected.

Since the load sensor having the above configuration has a structure in which the second electrically-conductive member having a linear shape and covered by the dielectric body is sandwiched by a substrate and the first electrically-conductive member, a gap is caused between the substrate and the first electrically-conductive member. Therefore, there is a problem that water or oil, foreign matter, or the like is likely to enter this gap, and accordingly, characteristics of the load sensor are likely to be deteriorated.

Such a problem can be solved by sealing the load sensor in an airtight manner by a sealing member. However, in this case, when the load sensor is sealed in a vacuum state, the air pressure of the space inside the sealing member becomes lower than the outside air pressure, and accordingly, a pressure due to this air pressure difference is applied to the load sensor. Therefore, the load sensor enters a state of detecting a load due to this air pressure difference even though no load is applied.

On the other hand, when the load sensor is sealed in an airtight manner by a sealing member such that the air pressure of the space inside the sealing member becomes higher than the outside air pressure, the applied load is pushed back by the sealing member. Therefore, the load is not accurately detected by the load sensor, and the load detection accuracy decreases.

### SUMMARY OF THE INVENTION

A main aspect of the present invention relates to a load detecting device. The load detecting device according to the present aspect includes a load sensor and a sealing member encapsulating the load sensor. The load sensor includes: an upper substrate having elasticity; a lower substrate disposed so as to oppose the upper substrate; at least one electrically-conductive elastic body formed on at least one of an opposing face of the upper substrate and an opposing face of the lower substrate; at least one linear electrically-conductive member disposed between the upper substrate and the lower substrate; and a dielectric body formed on an outer periphery of the linear electrically-conductive member. The sealing member includes: a lower sealing member on which the load sensor is placed; an upper sealing member covering an upper face of the load sensor and joined to the lower sealing member; and an air pressure adjustment structure configured to cause an air pressure in an accommodation space, of the load sensor, formed by the lower sealing member and the upper sealing member to be approximately equal to an outside air pressure.

According to the load detecting device of the present aspect, since the load sensor is encapsulated in the sealing member, water or oil, foreign matter, or the like is less likely to enter the gap between the upper substrate and the lower substrate. Therefore, deterioration of characteristics of the load sensor due to entry of these can be prevented. Since the air pressure in the accommodation space of the load sensor becomes approximately equal to the outside air pressure due to the air pressure adjustment structure, decrease in the detection accuracy due to the air pressure difference between the accommodation space and the outside can be suppressed. Therefore, the applied load can be accurately detected.

The effects and the significance of the present invention will be further clarified by the description of the embodiments below. However, the embodiments below are merely examples for implementing the present invention. The present invention is not limited to the description of the embodiments below in any way.

### BRIEF DESCRIPTION OF THE DRAWINGS

FIG. 1A is a perspective view schematically showing an upper substrate and electrically-conductive parts formed on the opposing face of the upper substrate according to Embodiment 1;

FIG. 1B is a perspective view schematically showing a state where electrically-conductive elastic bodies are disposed on the structure in FIG. 1A according to Embodiment 1;

FIG. 2A is a perspective view schematically showing a lower substrate and electric conductors, wires, and terminal parts that are formed on the opposing face of the lower substrate according to Embodiment 1;

FIG. 2B is a perspective view schematically showing a state where an insulation film is set on the structure in FIG. 2A according to Embodiment 1;

FIG. 3A is a perspective view schematically showing a state where conductor wires, a substrate, and connectors are disposed on the structure in FIG. 2B according to Embodiment 1;

FIG. 3B is a perspective view schematically showing a state where the structure in FIG. 1B is set on the structure in FIG. 3A according to Embodiment 1;

FIG. 4A and FIG. 4B each schematically show a cross section of an element part along a plane parallel to an X-Z plane at the center position in the Y-axis direction of the element part according to Embodiment 1;

FIG. 5 is a plan view schematically showing disposition of components of the load sensor when viewed in the Z-axis negative direction according to Embodiment 1;

FIG. 6 is a schematic diagram showing an example of the potential of each component according to Embodiment 1;

FIG. 7A and FIG. 7B are respectively a plan view and a cross-sectional view schematically showing a configuration of a load detecting device according to Embodiment 1;

FIG. 8A and FIG. 8B are respectively a plan view and a cross-sectional view schematically showing a configuration of the load detecting device according to a modification of Embodiment 1;

FIG. 9A and FIG. 9B are respectively a plan view and a cross-sectional view schematically showing a configuration of the load detecting device according to Embodiment 2;

FIG. 10A and FIG. 10B are respectively a plan view and a cross-sectional view schematically showing a configuration of the load detecting device according to a modification of Embodiment 2;

FIG. 11A and FIG. 11B are respectively a plan view and a cross-sectional view schematically showing a configuration of the load detecting device according to Embodiment 3;

FIG. 12A and FIG. 12B are respectively a plan view and a cross-sectional view schematically showing a configuration of the load detecting device according to a modification of Embodiment 3;

FIG. 13A and FIG. 13B are respectively a plan view and a cross-sectional view schematically showing a configuration of the load detecting device according to Embodiment 4;

FIG. 14 is a plan view schematically showing a configuration of the load detecting device according to a modification of Embodiment 4;

FIG. 15 is a cross-sectional view schematically showing a configuration of the load detecting device according to the modification of Embodiment 4;

FIG. 16A is a cross-sectional view schematically showing a configuration of the load detecting device in the vicinity of a boundary according to Comparative Example;

FIG. 16B is a cross-sectional view schematically showing a configuration of the load detecting device in the vicinity of a boundary according to the modification of Embodiment 4;

FIG. 17A is a cross-sectional view schematically showing the load detecting device when an electrically-conductive coating is provided to the surface on the outer side of a sealing member according to Embodiment 5;

FIG. 17B is a cross-sectional view schematically showing the load detecting device when the sealing member is formed from an electrically-conductive material according to Embodiment 5; and

FIG. 18 is a cross-sectional view schematically showing a configuration of the load detecting device according to another modification.

It is noted that the drawings are solely for description and do not limit the scope of the present invention in any way.

### DETAILED DESCRIPTION

A load sensor according to the present invention is applicable to a load sensor of a management system or an electronic apparatus that performs processing in accordance with an applied load.

Examples of the management system include a stock management system, a driver monitoring system, a coaching management system, a security management system, and a caregiving/nursing management system.

In the stock management system, for example, by a load sensor provided to a stock shelf, the load of a placed stock is detected, and the kinds of commodities and the number of commodities present on the stock shelf are detected. Accordingly, in a store, a factory, a warehouse, and the like, the stock can be efficiently managed, and manpower saving can be realized. In addition, by a load sensor provided in a refrigerator, the load of food in the refrigerator is detected, and the kinds of the food and the quantity and amount of the food in the refrigerator are detected. Accordingly, a menu that uses food in a refrigerator can be automatically proposed.

In the driver monitoring system, by a load sensor provided to a steering device, the distribution of a load (e.g., gripping force, grip position, tread force) applied to the steering device by a driver is monitored, for example. In addition, by a load sensor provided to a vehicle-mounted seat, the distribution of a load (e.g., the position of the center of gravity) applied to the vehicle-mounted seat by the driver in a seated state is monitored. Accordingly, the driving state (sleepiness, mental state, and the like) of the driver can be fed back.

In the coaching management system, for example, by a load sensor provided to the bottom of a shoe, the load distribution at a sole is monitored. Accordingly, correction or guidance to an appropriate walking state or running state can be realized.

In the security management system, for example, by a load sensor provided to a floor, the load distribution is detected when a person passes, and the body weight, stride, passing speed, shoe sole pattern, and the like are detected. Accordingly, the person who has passed can be identified by checking these pieces of detection information against data.

In the caregiving/nursing management system, for example, by load sensors provided to bedclothes and a toilet seat, the distributions of loads applied by a human body to the bedclothes and the toilet seat are monitored. Accordingly, at the positions of the bedclothes and the toilet seat, what action the person is going to take is estimated, whereby tumbling or falling can be prevented.

Examples of the electronic apparatus include a vehicle-mounted apparatus (car navigation system, audio apparatus, etc.), a household electrical appliance (electric pot, IH cooking heater, etc.), a smartphone, an electronic paper, an electronic book reader, a PC keyboard, a game controller, a smartwatch, a wireless earphone, a touch panel, an electronic pen, a penlight, lighting clothes, and a musical instrument. In an electronic apparatus, a load sensor is provided to an input part that receives an input from a user.

The load sensor in the embodiments below is a capacitance-type load sensor that is typically provided in a load sensor of a management system or an electronic apparatus as described above. Such a load sensor may be referred to as a “capacitance-type pressure-sensitive sensor element”, a “capacitive pressure detection sensor element”, a “pressure-sensitive switch element”, or the like. The load detecting device in the embodiments below includes a load sensor and a sealing member that encapsulates the load sensor. The load detecting device is connected to an external detection circuit, and the load detecting device and the detection circuit form a load detection system. The embodiments below are some examples of embodiments of the present invention, and the present invention is not limited to the embodiments below in any way.

Hereinafter, embodiments of the present invention will be described with reference to the drawings. For convenience, X-, Y-, and Z-axes orthogonal to each other are indicated in the drawings. The Z-axis direction is the height direction of the load sensor and the load detecting device.

### Embodiment 1

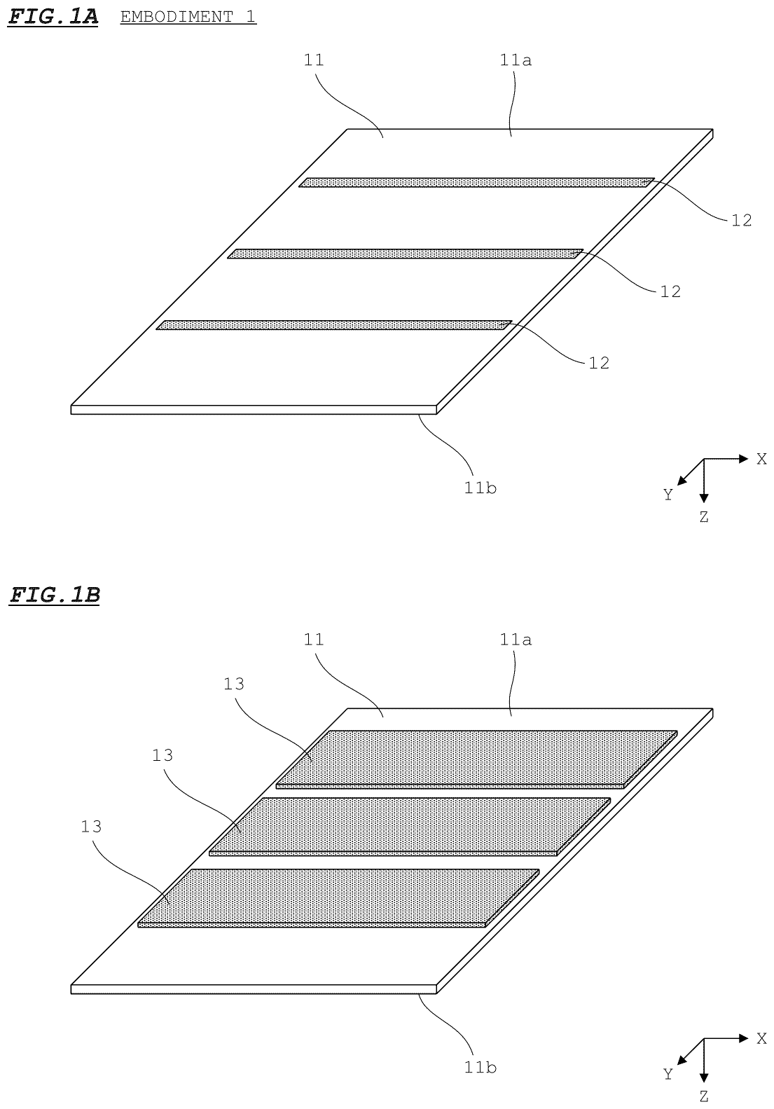

FIG. 1A is a perspective view schematically showing an upper substrate 11 and electrically-conductive parts 12 formed on an opposing face 11a (the face on the Z-axis negative side) of the upper substrate 11.

The upper substrate 11 is an insulative member having elasticity. The upper substrate 11 is a plate-shaped member having flat planes on the Z-axis positive side and the Z-axis negative side. The planes on the Z-axis positive side and the Z-axis negative side of the upper substrate 11 are parallel to an X-Y plane. The thickness of the upper substrate 11 is about 0.1 mm to 1.2 mm, for example. The elastic modulus of the upper substrate 11 is, for example, about 0.01 MPa to 10 MPa, and more specifically is about 1 MPa to 5 MPa.

The upper substrate 11 is formed from a non-electrically-conductive resin material or a non-electrically-conductive rubber material. The resin material used in the upper substrate 11 is a resin material of at least one type selected from the group consisting of a styrene-based resin, a silicone-based resin (e.g., polydimethylpolysiloxane (PDMS)), an acrylic resin, a rotaxane-based resin, a urethane-based resin, and the like, for example. The rubber material used in the upper substrate 11 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like, for example.

Each electrically-conductive part 12 is formed on the opposing face 11a of the upper substrate 11. Here, three electrically-conductive parts 12 are disposed on the opposing face 11a of the upper substrate 11 so as to extend in the X-axis direction. The three electrically-conductive parts 12 are formed so as to be arranged in the Y-axis direction with a predetermined gap therebetween. Each electrically-conductive part 12 is formed from a material having a resistance lower than that of an electrically-conductive elastic body 13 described later. The thickness of the electrically-conductive part 12 is smaller than the thickness of the electrically-conductive elastic body 13 described later. The width in the Y-axis direction of the electrically-conductive part 12 is smaller than the width of the electrically-conductive elastic body 13 described later.

The electrically-conductive part 12 may be omitted. However, when the electrically-conductive part 12 is provided with respect to the electrically-conductive elastic body 13 described later, the electric conductivity of the structure composed of the electrically-conductive elastic body 13 and the electrically-conductive part 12 can be made higher than the electric conductivity of the electrically-conductive elastic body 13 only.

FIG. 1B is a perspective view schematically showing a state where the electrically-conductive elastic bodies 13 are disposed on the structure in FIG. 1A.

Each electrically-conductive elastic body 13 is formed on the opposing face 11a of the upper substrate 11 so as to cover a corresponding electrically-conductive part 12. The electrically-conductive elastic body 13 is formed on the opposing face 11a such that the electrically-conductive part 12 is positioned at an approximately middle position of the electrically-conductive elastic body 13 in the Y-axis direction. Here, three electrically-conductive elastic bodies 13 are disposed on the opposing face 11a of the upper substrate 11 so as to extend in the X-axis direction. The three electrically-conductive elastic bodies 13 are formed so as to be arranged in the Y-axis direction with a predetermined gap therebetween.

Each electrically-conductive elastic body 13 is a member that is electrically conductive and that has elasticity. The electrically-conductive part 12 and the electrically-conductive elastic body 13 formed so as to cover the electrically-conductive part 12 are in a state of being electrically connected to each other. The electrically-conductive part 12 and the electrically-conductive elastic body 13 are each formed from a resin material and an electrically-conductive filler dispersed therein, or from a rubber material and an electrically-conductive filler dispersed therein.

Similar to the resin material used in the upper substrate 11 described above, the resin material used in the electrically-conductive part 12 and the electrically-conductive elastic body 13 is a resin material of at least one type selected from the group consisting of a styrene-based resin, a silicone-based resin (e.g., polydimethylpolysiloxane (PDMS)), an acrylic resin, a rotaxane-based resin, a urethane-based resin, and the like, for example. Similar to the rubber material used in the upper substrate 11 described above, the rubber material used in the electrically-conductive part 12 and the electrically-conductive elastic body 13 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like, for example.

The electrically-conductive filler forming the electrically-conductive part 12 and the electrically-conductive elastic body 13 is a material of at least one type selected from the group consisting of: metal materials such as Au (gold), Ag (silver), Cu (copper), C (carbon), ZnO (zinc oxide), In₂O₃ (indium oxide (III)), and SnO₂ (tin oxide (IV)); electrically-conductive macromolecule materials such as PEDOT: PSS (i.e., a complex composed of poly(3,4-ethylenedioxythiophene) (PEDOT) and polystyrene sulfonate (PSS)); and electrically-conductive fibers such as a metal-coated organic matter fiber and a metal wire (fiber state), for example.

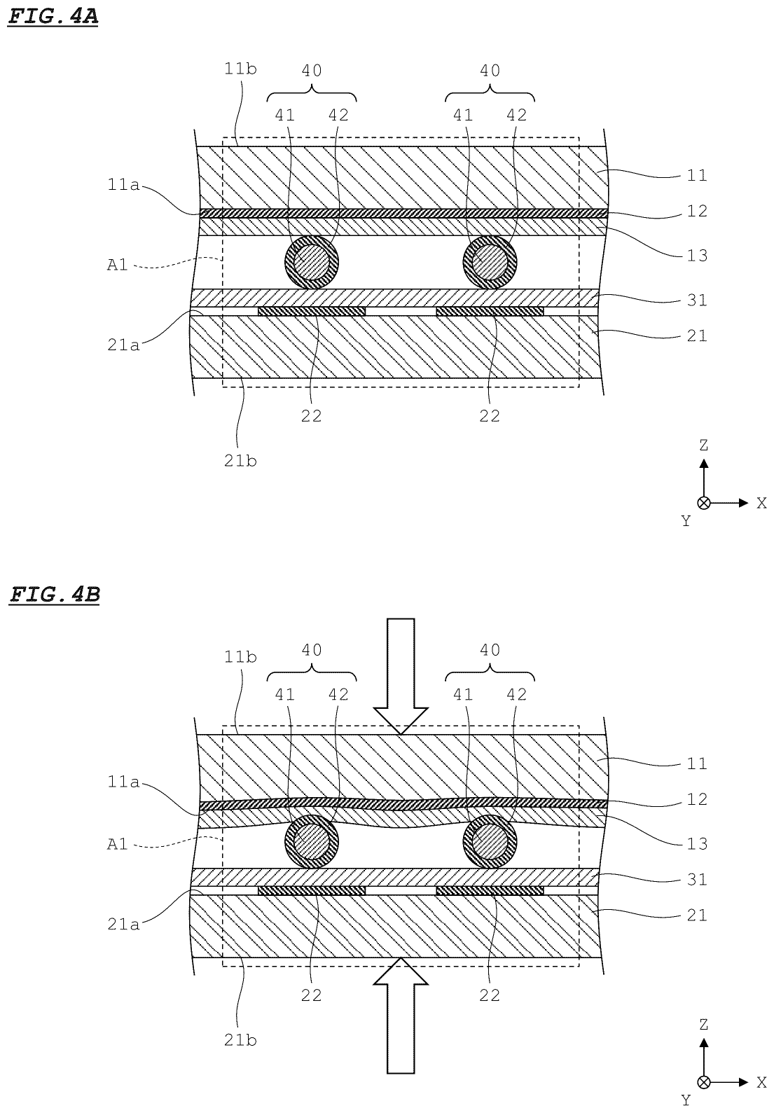

In Embodiment 1, the electrically-conductive filler forming the electrically-conductive part 12 is Ag (silver), and the electrically-conductive filler forming the electrically-conductive elastic body 13 is C (carbon). Accordingly, the electrically-conductive part 12 has a higher electric conductivity than the electrically-conductive elastic body 13. In general, a material having a high electric conductivity is expensive. However, in this configuration, the amount of the electrically-conductive part 12 having a high electric conductivity can be reduced, and thus, the cost of the electrically-conductive part 12 can be kept low. In addition, in general, when an elastic body includes a material having a high electric conductivity, the elastic modulus becomes high (the elastic body itself becomes hard). However, in this configuration, since the width in the Y-axis direction of the electrically-conductive part 12 at the position of an electrically-conductive member 41 described later (see FIGS. 4A, 4B) is small, the elastic modulus of the structure composed of the electrically-conductive part 12 and the electrically-conductive elastic body 13 can be kept low. Therefore, the capacitance is allowed to smoothly change in accordance with the load.

In Embodiment 1, the elastic modulus of the electrically-conductive elastic body 13 is set to be at about the same level as the elastic modulus of the upper substrate 11. Since the electrically-conductive part 12 includes Ag (silver) as the electrically-conductive filler, the elastic modulus of the electrically-conductive part 12 is slightly higher than the elastic modulus of the electrically-conductive elastic body 13, and is several MPa or more or several tens of MPa or more, for example.

The electrically-conductive part 12 and the electrically-conductive elastic body 13 are formed on the opposing face 11a of the upper substrate 11 by a printing method such as screen printing, gravure printing, flexographic printing, offset printing, or gravure offset printing. After the electrically-conductive part 12 is formed as shown in FIG. 1A, the electrically-conductive elastic body 13 is formed so as to overlap the electrically-conductive part 12 as shown in FIG. 1B. With these printing methods, the electrically-conductive part 12 and the electrically-conductive elastic body 13 can be formed so as to have a thickness of about 0.001 mm to 0.5 mm on the opposing face 11a of the upper substrate 11. However, the method for forming the electrically-conductive part 12 and the electrically-conductive elastic body 13 is not limited the above printing methods.

The structure shown in FIG. 1B is disposed upside down during assembly described later. Accordingly, the face on the Z-axis positive side of the upper substrate 11 becomes an upper face 11b.

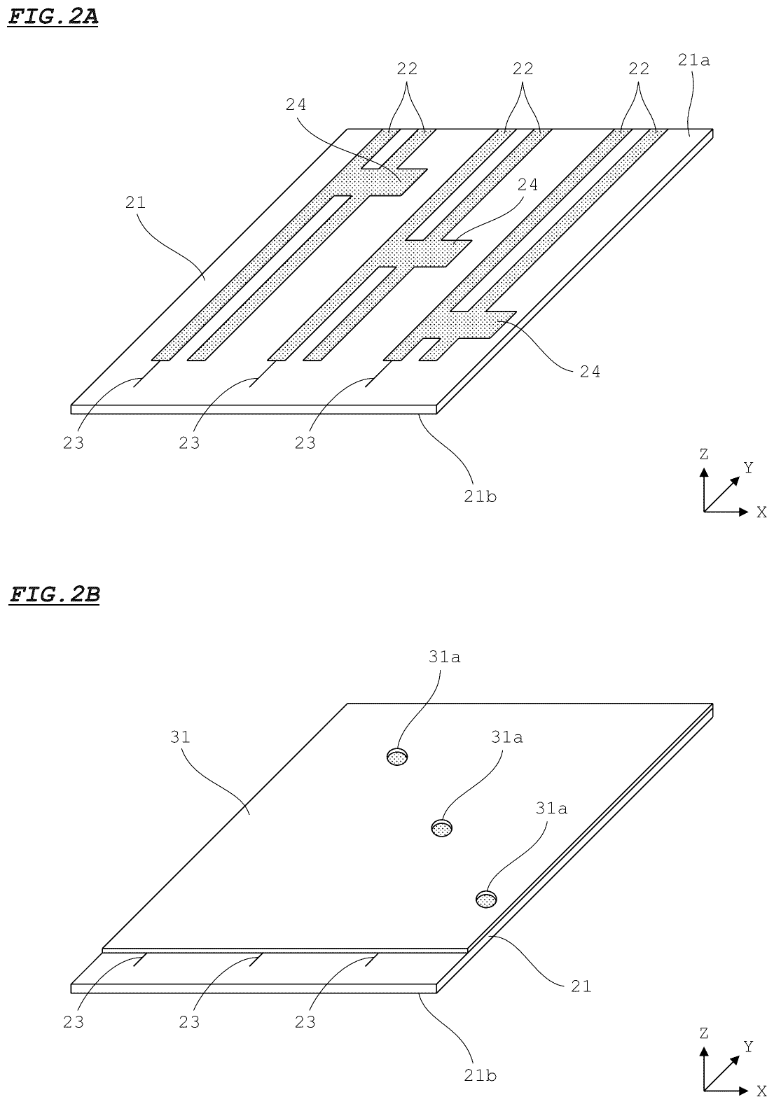

FIG. 2A is a perspective view schematically showing a lower substrate 21, and electric conductors 22, wires 23, and terminal parts 24 that are formed on an opposing face 21a (the face on the Z-axis positive side) of the lower substrate 21.

The lower substrate 21 is an insulative member. The lower substrate 21 is a plate-shaped member having flat planes on the Z-axis positive side and the Z-axis negative side. The planes on the Z-axis positive side and the Z-axis negative side of the lower substrate 21 are parallel to an X-Y plane. As described later, the lower substrate 21 is disposed so as to oppose the upper substrate 11. The thickness of the lower substrate 21 is about 0.1 mm to 1.5 mm, for example. The rigidity of the lower substrate 21 is high, and the elastic modulus of the lower substrate 21 is 30 MPa or more.

The lower substrate 21 is formed from a non-electrically-conductive resin material. The resin material used in the lower substrate 21 is a resin material of at least one type selected from the group consisting of polyurethane, polyethylene terephthalate, polyethylene, polycarbonate, polyimide, and the like, for example.

The electric conductors 22 and the wires 23 are formed on the opposing face 21a of the lower substrate 21. Here, six electric conductors 22 extending in the Y-axis direction are arranged with a predetermined gap therebetween in the X-axis direction, and three sets (each being a pair of electric conductors 22) each composed of adjacent two electric conductors 22 are arranged in the X-axis direction. A wire 23 extends from an end portion on the Y-axis negative side of each pair of electric conductors 22. Adjacent electric conductors 22 of each pair are connected together at a predetermined position in the Y-axis direction, and from this connection position, a terminal part 24 protrudes in the X-axis positive direction. For one pair of electric conductors 22, one terminal part 24 is disposed. The three terminal parts 24 are respectively disposed at positions opposing the three electrically-conductive elastic bodies 13 shown in FIG. 1B.

A pair of electric conductors 22, a wire 23 connected to the pair of electric conductors 22, and a terminal part 24 protruding from the pair of electric conductors 22 are integrally formed and are in a state of being electrically connected to each other. The electric conductor 22, the wire 23, and the terminal part 24 are formed from the same material with each other, and similar to the electrically-conductive part 12 described above, are formed from a resin material and an electrically-conductive filler dispersed therein, or from a rubber material and an electrically-conductive filler dispersed therein. In Embodiment 1, the electrically-conductive filler forming the electric conductor 22, the wire 23, and the terminal part 24 is Ag (silver).

The electric conductor 22, the wire 23, and the terminal part 24 are formed on the opposing face 21a of the lower substrate 21 by a printing method such as screen printing, gravure printing, flexographic printing, offset printing, or gravure offset printing. With these printing methods, each component can be formed so as to have a thickness of about 0.001 mm to 0.5 mm on the opposing face 21a of the lower substrate 21. However, the method for forming each component is not limited the above printing methods.

FIG. 2B is a perspective view schematically showing a state where an insulation film 31 is set on the structure in FIG. 2A.

The insulation film 31 is an insulative member. The insulation film 31 is a sheet-shaped member and is parallel to an X-Y plane. The thickness of the insulation film 31 is 0.03 mm, for example. The elastic modulus of the insulation film 31 is 30 MPa or more. The insulation film 31 is formed from a non-electrically-conductive resin material. The resin material used in the insulation film 31 is a resin material of at least one type selected from the group consisting of polyurethane, polyethylene terephthalate, polyethylene, polycarbonate, polyimide, and the like, for example.

An end portion on the Y-axis negative side of the wire 23 extends to the vicinity of an end portion on the Y-axis negative side of the lower substrate 21, and the insulation film 31 is not provided at the end portion on the Y-axis negative side of the lower substrate 21. In the insulation film 31, at a position corresponding to an end portion on the X-axis positive direction of each terminal part 24 in FIG. 2A, a hole 31a penetrating the insulation film 31 in the up-down direction is formed. The hole 31a is used for joining the electrically-conductive elastic body 13 and the terminal part 24 as described later.

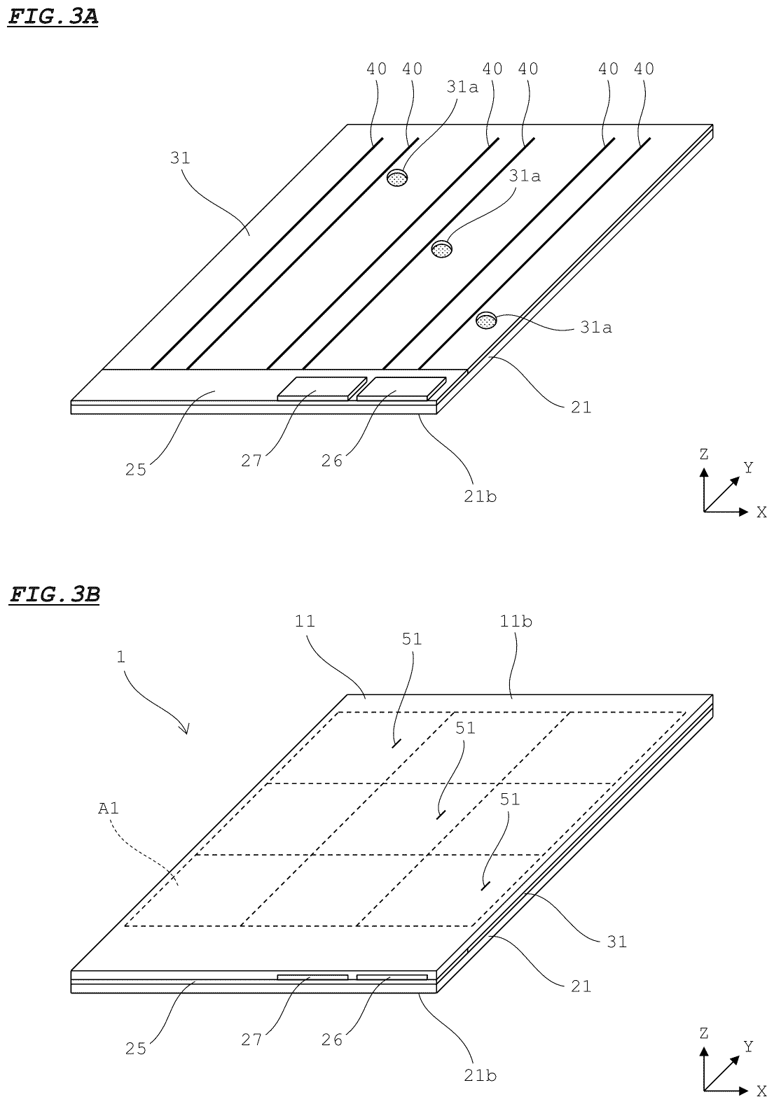

FIG. 3A is a perspective view schematically showing a state where conductor wires 40, a substrate 25, and connectors 26, 27 are disposed on the structure in FIG. 2B.

The conductor wires 40 are disposed so as to be superposed on the upper face of the insulation film 31. Here, six conductor wires 40 extending in the Y-axis direction are arranged with a predetermined gap therebetween in the X-axis direction, and three sets (each being a pair of conductor wires 40) each composed of adjacent two conductor wires 40 are arranged in the X-axis direction. In a plan view, the six conductor wires 40 are disposed at the same positions as the six electric conductors 22 shown in FIG. 2A. Two conductor wires 40 forming a pair are connected to each other in an external detection circuit in a subsequent stage. The conductor wires 40 forming a pair may be connected at an end portion on the Y-axis positive side.

Each conductor wire 40 is composed of: an electrically-conductive member 41 having a linear shape; and a dielectric body 42 formed on the surface of the electrically-conductive member 41. The configuration of the conductor wire 40 will be described later with reference to FIGS. 4A, 4B. Each conductor wire 40 is set to the lower substrate 21 by a thread so as to be able to move in the direction (the Y-axis direction) in which the conductor wire 40 extends.

After the conductor wires 40 have been disposed as in FIG. 3A, the substrate 25 is set on the upper face in the end portion on the Y-axis negative side of the lower substrate 21. On the upper face of the substrate 25, the connectors 26, 27 are set so as to be arranged in the X-axis direction. When the substrate 25 is set, end portions on the Y-axis negative side of the wires 23 shown in FIG. 2B and end portions on the Y-axis negative side of the conductor wires 40 shown in FIG. 3A are connected to wires provided to the substrate 25. Accordingly, the three wires 23 are connected to a predetermined terminal of the connector 26 via the wire in the substrate 25, and the six conductor wires 40 are connected to a predetermined terminal of the connector 27 via the wire in the substrate 25. The connectors 26, 27 are connected to the external detection circuit.

FIG. 3B is a perspective view schematically showing a state where the structure in FIG. 1B is set on the structure in FIG. 3A.

The structure in FIG. 1B is flipped upside down, and superposed on the structure in FIG. 3A from above (the Z-axis positive side). Accordingly, the conductor wires 40 come into contact with the electrically-conductive elastic bodies 13 disposed on the upper substrate 11.

Then, threads 51 are sewn to the upper face 11b of the upper substrate 11 and a lower face 21b of the lower substrate 21 through the holes 31a. At this time, an electrically-conductive elastic body 13 is positioned above each hole 31a, and a terminal part 24 is positioned below the hole 31a. Therefore, as a result of the threads 51 being sewn to the upper face 11b and the lower face 21b, the electrically-conductive elastic bodies 13 and the terminal parts 24 are pressed against each other to be electrically connected. Each thread 51 is implemented by a chemical fiber, a natural fiber, a mixed fiber of the chemical fiber and the natural fiber, or the like, and is formed from a non-electrically-conductive material.

The outer periphery of the upper substrate 11 is connected to the lower substrate 21 by a thread, whereby the upper substrate 11 is fixed to the lower substrate 21. In this manner, a load sensor 1 is completed as shown in FIG. 3B.

The load sensor 1 is used in a state where the upper substrate 11 is oriented to the upper side (the Z-axis positive side) and the lower substrate 21 is oriented to the lower side (the Z-axis negative side). In this case, the upper face 11b of the upper substrate 11 serves as the face to which a load is applied, and the lower face 21b of the lower substrate 21 serves as the placement face.

Here, in the load sensor 1, in a plan view, a plurality of element parts A1 arranged in a matrix shape are formed. In the example shown in FIG. 3B, in the load sensor 1, a total of nine element parts A1 arranged in the X-axis direction and the Y-axis direction are formed. One element part A1 corresponds to a region including the intersection between an electrically-conductive elastic body 13 and a pair of conductor wires 40 disposed below the electrically-conductive elastic body 13. That is, one element part A1 includes the upper substrate 11, the electrically-conductive part 12, the electrically-conductive elastic body 13, the conductor wires 40, and the lower substrate 21 that are present near the intersection. When the lower face (the lower face 21b of the lower substrate 21) of the load sensor 1 is set on a predetermined installation face, and a load is applied to the upper face (the upper face 11b of the upper substrate 11) of the load sensor 1 forming the element part A1, the capacitance between the electrically-conductive elastic body 13 and the electrically-conductive member 41 in each conductor wire 40 changes and the load is detected based on the capacitance.

FIGS. 4A, 4B each schematically show a cross section of an element part A1 along a plane parallel to an X-Z plane at the center position in the Y-axis direction of the element part A1.

FIG. 4A shows a state where no load is applied, and FIG. 4B shows a state where loads are applied. In FIGS. 4A, 4B, the lower face 21b on the Z-axis negative side of the lower substrate 21 is set on the installation face.

As shown in FIGS. 4A, 4B, each conductor wire 40 is composed of the electrically-conductive member 41 and the dielectric body 42 formed on the electrically-conductive member 41. The dielectric body 42 is formed on the outer periphery of the electrically-conductive member 41 and covers the surface of the electrically-conductive member 41.

The electrically-conductive member 41 is a member having a linear shape. The electrically-conductive member 41 is formed from an electrically-conductive metal material, for example. Other than this, the electrically-conductive member 41 may be composed of a core wire made of glass, and an electrically-conductive layer formed on the surface of the core wire, or may be composed of a core wire made of resin, and an electrically-conductive layer formed on the surface of the core wire, for example. For example, as the electrically-conductive member 41, a valve action metal such as aluminum (Al), titanium (Ti), tantalum (Ta), niobium (Nb), zirconium (Zr), or hafnium (Hf); tungsten (W); molybdenum (Mo); copper (Cu); nickel (Ni); silver (Ag); gold (Au); or the like is used.

The dielectric body 42 has an insulation property, and is formed from a resin material, a ceramic material, a metal oxide material, or the like, for example. The material of the dielectric body 42 may be a resin material of at least one type selected from the group consisting of a polypropylene resin, a polyester resin (e.g., polyethylene terephthalate resin), a polyimide resin, a polyphenylene sulfide resin, a polyvinyl formal resin, a polyurethane resin, a polyamide imide resin, a polyamide resin, and the like. Alternatively, the material of the dielectric body 42 may be a metal oxide material of at least one type selected from the group consisting of Al₂O₃, Ta₂O₅, and the like.

As shown in FIG. 4A, when no load is applied to the element part A1, the force applied between the electrically-conductive elastic body 13 and the conductor wire 40, and the force applied between the insulation film 31 and the conductor wire 40 are approximately zero. From this state, as shown in FIG. 4B, when a load is applied in the downward direction to the upper face 11b of the element part A1, the electrically-conductive elastic body 13, the electrically-conductive part 12, and the upper substrate 11 are deformed by the conductor wire 40.

When loads are applied as shown in FIG. 4B, the conductor wire 40 is brought close to the electrically-conductive elastic body 13 so as to be wrapped by the electrically-conductive elastic body 13, and the contact area between the conductor wire 40 and the electrically-conductive elastic body 13 increases. Accordingly, the capacitance between the electrically-conductive member 41 and the electrically-conductive elastic body 13 changes. Then, the potential reflecting the change in the capacitance in the element part A1 is measured by the external circuit, whereby the load applied to the element part A1 is calculated.

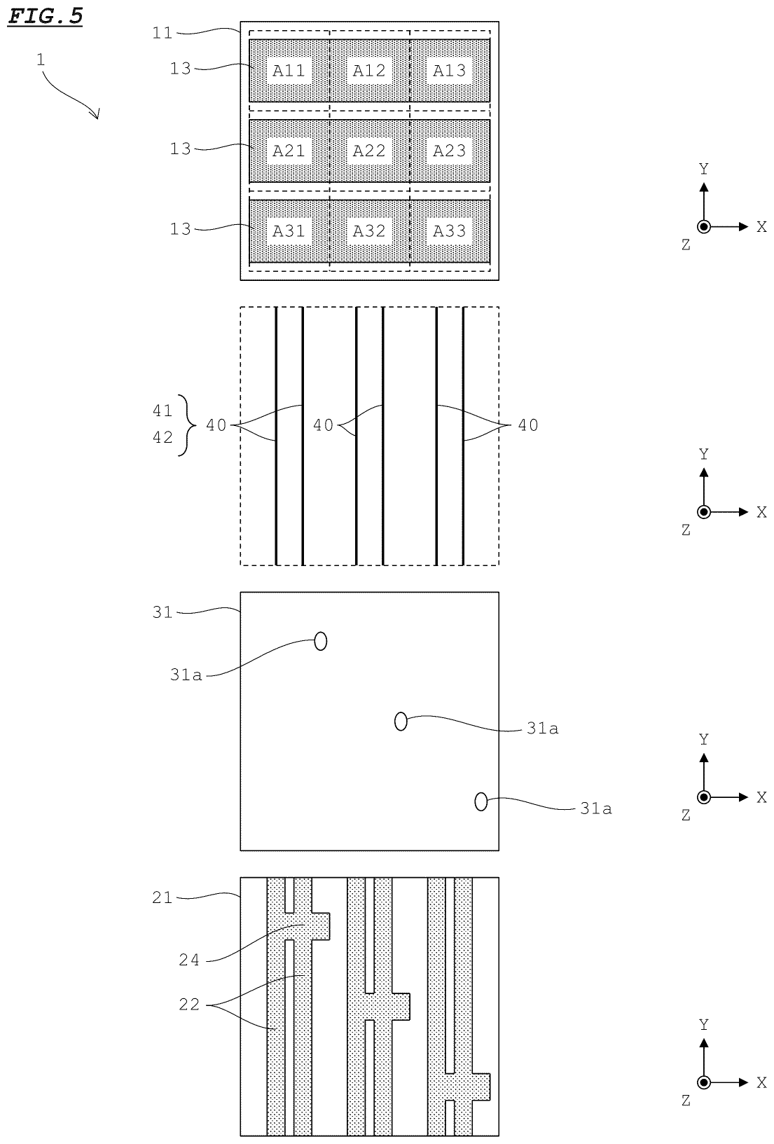

FIG. 5 is a plan view schematically showing disposition of components of the load sensor 1 when viewed in the Z-axis negative direction.

In FIG. 5, for convenience, a layer composed of the upper substrate 11 and the electrically-conductive elastic bodies 13, a layer composed of the conductor wires 40, a layer composed of the insulation film 31, and a layer composed of the lower substrate 21, the electric conductors 22, and the terminal parts 24 are arranged to be shown. The electrically-conductive elastic bodies 13 are shown in a state of being seen through the upper substrate 11.

In the measurement region of the load sensor 1, as described above, nine element parts A1 arranged in a matrix shape are formed. The nine element parts A1 correspond to nine positions at each of which an electrically-conductive elastic body 13 and a pair of conductor wires 40 cross each other. Hereinafter, these nine element parts A1 will be referred to as A11, A12, A13, A21, A22, A23, A31, A32, A33.

The electrically-conductive elastic body 13 corresponding to the element parts A11 to A13 is connected to the terminal part 24 connected to the pair of electric conductors 22 on the X-axis negative side, through the hole 31a on the X-axis negative side. Similarly, the electrically-conductive elastic body 13 corresponding to the element parts A21 to A23 is connected to the terminal part 24 connected to the pair of electric conductors 22 at the center, through the hole 31a at the center. The electrically-conductive elastic body 13 corresponding to the element parts A31 to A33 is connected to the terminal part 24 connected to the pair of electric conductors 22 on the X-axis positive side, through the hole 31a on the X-axis positive side. The external circuit sequentially changes the element part to serve as a load detection target, at a predetermined time interval.

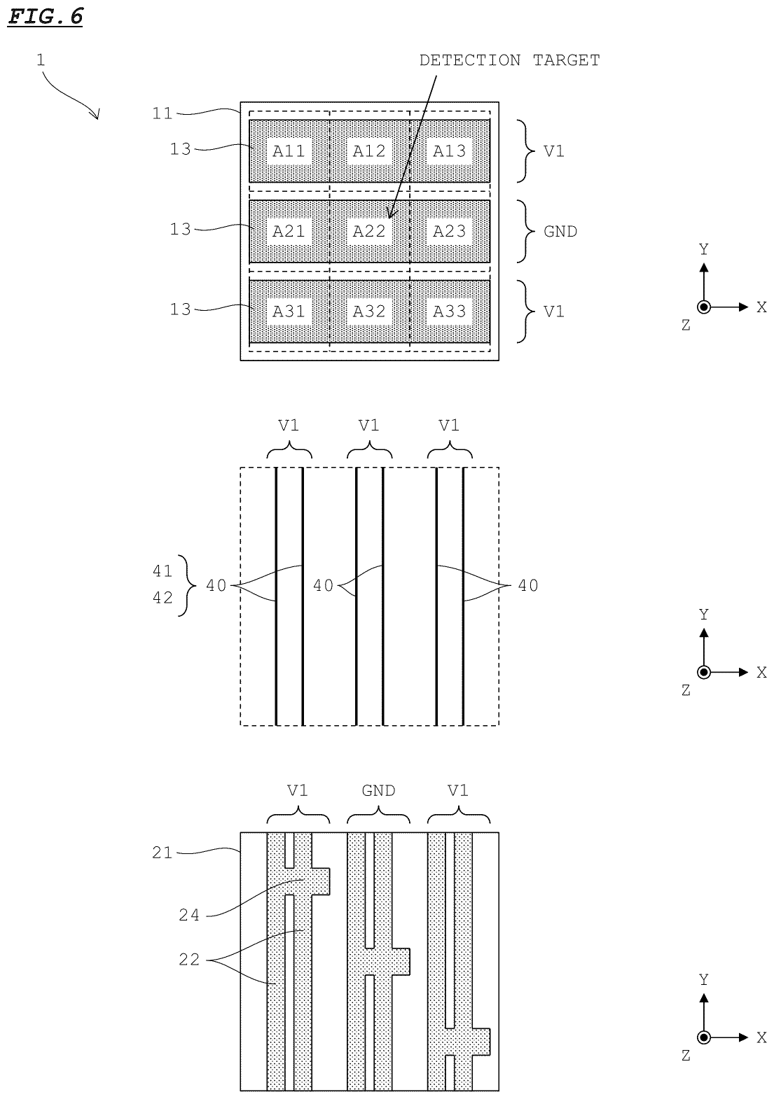

FIG. 6 is a schematic diagram showing the potential of each component when the element part A22 is the load detection target. Hereinafter, as an example, a procedure of detecting, when a load is applied to the element part A22 from the upper face 11b (see FIG. 3B) of the upper substrate 11, the load applied to the element part A22 will be described.

The external circuit connects the electrically-conductive elastic body 13 at the center corresponding to the element part A22 to the ground, and applies a constant voltage (Vcc) to the electrically-conductive members 41 in the pair of conductor wires 40 corresponding to the element part A22. Specifically, the external circuit connects the pair of electric conductors 22 at the center to the ground, thereby connecting the electrically-conductive elastic body 13 at the center to the ground. In addition, the external circuit applies the constant voltage (Vcc) to the electrically-conductive members 41 in the pair of conductor wires 40 at the center. Accordingly, the potential of the electrically-conductive elastic body 13 at the center becomes the ground potential (GND), and a potential V1 of the electrically-conductive members 41 in the pair of conductor wires 40 at the center gradually increases according to the time constant based on the capacitance in the element part A22.

Further, the external circuit sets the potentials of the electrically-conductive elastic bodies 13 and the electrically-conductive members 41 other than the element part A22 serving as the detection target, to the potential V1, which is the same as that of the pair of electrically-conductive members 41 at the center corresponding to the element part A22. Specifically, the external circuit sets the potential V1 for the pairs of electric conductors 22 on the X-axis positive side and the X-axis negative side, thereby setting the potential V1 for the electrically-conductive elastic bodies 13 on the Y-axis positive side and the Y-axis negative side. In addition, the external circuit sets the potential V1 for the electrically-conductive members 41 in the pairs of conductor wires 40 on the X-axis positive side and the X-axis negative side.

At a timing after elapse of a predetermined time from the application of the constant voltage (Vcc), the external circuit measures the potential V1 of the electrically-conductive members 41 corresponding to the element part A22 serving as the detection target. The external circuit calculates the capacitance in the element part A22, based on the measured potential V1. Then, the external circuit acquires the load applied to the element part A22, based on the calculated capacitance.

At the load acquisition as above, since the potential V1 or the ground potential (GND) is set for the electric conductors 22, the lower side of the conductor wires 40 is electrically shielded by the electric conductors 22. Therefore, even when a capacitance component comes close from the lower side of the conductor wires 40, occurrence of an error in change in the potential V1 is suppressed. In addition, since the potential V1 or the ground potential (GND) is set for the electrically-conductive elastic bodies 13, the upper side of the conductor wires 40 is electrically shielded by the electrically-conductive elastic bodies 13. Therefore, even when a capacitance component comes close from the upper side of the electrically-conductive elastic bodies 13, occurrence of an error in change in the potential V1 is suppressed.

Meanwhile, as shown in FIG. 4A, since the load sensor 1 as above has a structure in which the conductor wires 40 are sandwiched by the electrically-conductive elastic body 13 and the lower substrate 21, a gap is caused between the electrically-conductive elastic body 13 and the lower substrate 21. Therefore, water or oil, foreign matter, or the like is likely to enter this gap, and accordingly, characteristics of the load sensor 1 are likely to be deteriorated. Such a problem can be solved by sealing the load sensor 1 in an airtight manner by a sealing member. However, in this case, due to the difference between the air pressure of the space inside the sealing member and the outside air pressure, the load detection accuracy decreases.

In contrast, in Embodiment 1, as shown below, the load sensor 1 is encapsulated in a sealing member 60, and further, a configuration to suppress the air pressure difference between the inside of the sealing member 60 and the outside is provided. Accordingly, the load applied to the load sensor 1 can be accurately detected.

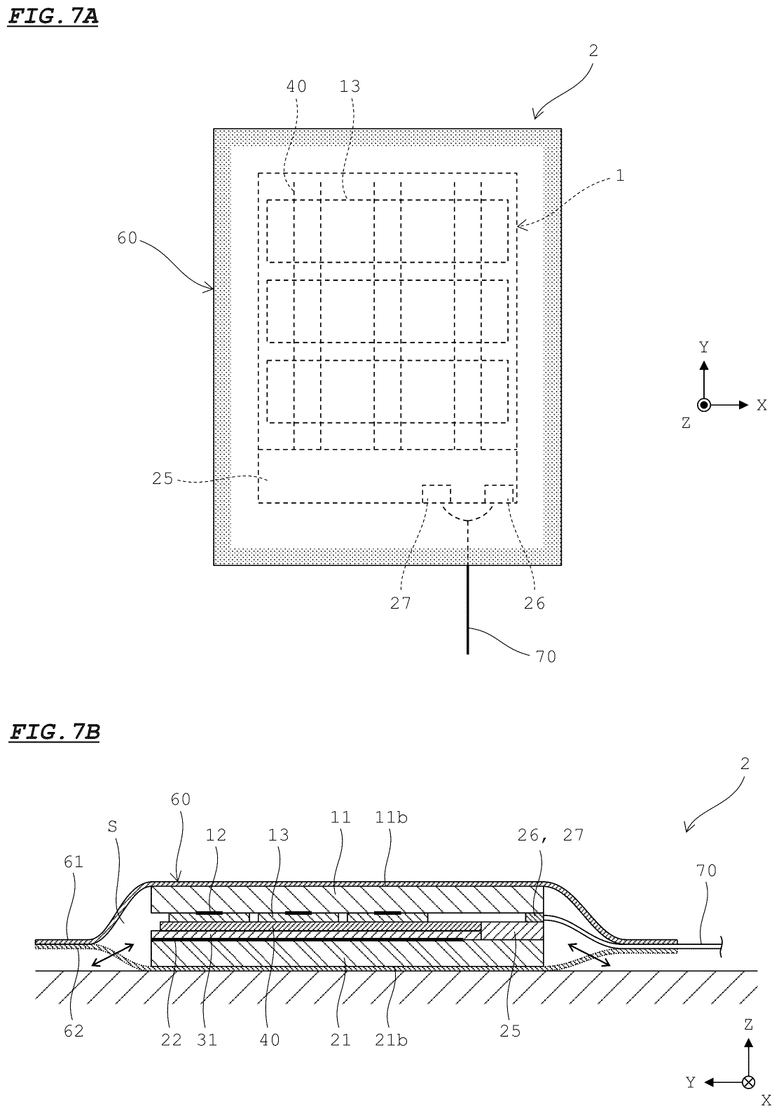

FIGS. 7A, 7B are respectively a plan view and a cross-sectional view schematically showing a configuration of a load detecting device 2. FIG. 7B is a diagram of a cross section of the load detecting device 2 along a Y-Z plane passing through a conductor wire 40 on the X-axis negative side, viewed in the X-axis positive direction.

As shown in FIGS. 7A, 7B, the load detecting device 2 includes the load sensor 1, the sealing member 60 encapsulating the load sensor 1, and a cable 70. The sealing member 60 has a rectangular shape in a plan view. The cable 70 is composed of a plurality of cables, and is connected to the connectors 26, 27.

As shown in FIG. 7B, the sealing member 60 includes: an upper sealing member 61 covering the upper face (the upper face 11b of the upper substrate 11) of the load sensor 1; and a lower sealing member 62 on which the load sensor 1 is placed.

The upper sealing member 61 is configured so as to have a low rigidity. Thus, when the upper sealing member 61 is configured to be soft, the load applied from above the load detecting device 2 is suppressed from spreading into an X-Y plane. Therefore, the applied load can be appropriately detected by a corresponding element part A1. From this point of view, the upper sealing member 61 is preferably configured such that the moment of inertia of area is ⅛ or less of that of the upper substrate 11 and the elastic modulus is ⅛ or less of that of the upper substrate 11, for example. In the upper sealing member 61, the moment of inertia of area may be larger than ⅛ of that of the upper substrate 11, and the elastic modulus may be larger than ⅛ of that of the upper substrate 11.

The upper sealing member 61 is composed of a constituting member having airtightness. The lower sealing member 62 is configured so as to have a higher rigidity than the upper sealing member 61.

The upper sealing member 61 is formed from a stretchable and insulative material. The upper sealing member 61 is formed from a resin material or a rubber material. The resin material used in the upper sealing member 61 is a resin material of at least one type selected from the group consisting of polyethylene terephthalate (PET), a urethane-based resin (polyurethane sheet), a styrene-based resin, a silicone-based resin (e.g., polydimethylpolysiloxane (PDMS)), an acrylic resin, a rotaxane-based resin, and the like, for example. The rubber material used in the upper sealing member 61 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like.

The upper sealing member 61 of Embodiment 1 is formed from a urethane-based resin (polyurethane sheet). Accordingly, the material of the upper sealing member 61 can be easily obtained, and the cost for the upper sealing member 61 can be suppressed.

The lower sealing member 62 is formed from a material similar to that of the upper sealing member 61. That is, the lower sealing member 62 is formed from a resin material or a rubber material. The resin material used in the lower sealing member 62 is a resin material of at least one type selected from the group consisting of polyethylene terephthalate (PET), a urethane-based resin (polyurethane sheet), a styrene-based resin, a silicone-based resin (e.g., polydimethylpolysiloxane (PDMS)), an acrylic resin, a rotaxane-based resin, and the like, for example. The rubber material used in the lower sealing member 62 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like.

The lower sealing member 62 of Embodiment 1 is formed from polyethylene terephthalate (PET). Accordingly, a desired rigidity of the lower sealing member 62 can be realized and the cost for the lower sealing member 62 can be suppressed.

During assembly, the load sensor 1 is placed on the upper face of the lower sealing member 62, and the upper sealing member 61 is disposed on the upper face 11b so as to be in close contact with the upper face (the upper face 11b of the upper substrate 11) of the load sensor 1.

For example, when the lower sealing member 62 is hard as in the present embodiment, if the upper sealing member 61 is joined to the lower sealing member 62 without slack, occurrence of slack in the upper sealing member 61 is suppressed by the rigidity of the lower sealing member 62. Accordingly, close contact between the upper sealing member 61 and the upper substrate 11 is maintained. When the upper sealing member 61 is joined to the lower sealing member 62 without slack in a state where a peripheral portion of the lower sealing member 62 is bent slightly upward, a tension that presses the upper sealing member 61 against the upper face 11b of the upper substrate 11 is caused by elastic return force of the lower sealing member 62. Accordingly, close contact between the upper sealing member 61 and the upper substrate 11 is further enhanced.

If static electricity occurs between the upper sealing member 61 and the upper substrate 11, the capacitance cannot be accurately measured, and the load detection accuracy decreases. In order to avoid this, it is preferable that the upper sealing member 61 and the upper substrate 11 are formed from materials whose ranks in the triboelectric series are close to each other. Accordingly, static electricity caused by friction between the upper sealing member 61 and the upper substrate 11 can be suppressed.

However, even if the upper sealing member 61 and the upper substrate 11 are formed from materials whose ranks in the triboelectric series are close to each other, static electricity may occur due to friction between the upper sealing member 61 and the upper substrate 11, and if their ranks in the triboelectric series are more separated from each other, static electricity is more likely to occur, accordingly. In order to prevent this, it is preferable that antistatic treatment is performed on the joint face between the upper sealing member 61 and the upper substrate 11. As the antistatic treatment, for example, a surfactant layer may be formed at the inner face on the upper sealing member 61 side.

In a state where the cable 70 is connected to the connectors 26, 27, the upper sealing member 61 and the lower sealing member 62 are joined together such that the upper sealing member 61 and the lower sealing member 62 sandwich the cable 70. Specifically, as indicated by hatching in FIG. 7A, an outer edge portion of the upper sealing member 61 and an outer edge portion of the lower sealing member 62 are bonded to each other with an adhesive. As a result of the upper sealing member 61 and the lower sealing member 62 being joined at the outer edge portions thereof, an accommodation space S is formed inside the sealing member 60.

The cable 70 need not necessarily be passed through the position where the upper sealing member 61 and the lower sealing member 62 are superposed on each other, and may be drawn out from the inside of the sealing member 60 to the outside through a hole provided to the upper sealing member 61 or the lower sealing member 62. In this case, the hole through which the cable 70 is passed is closed by an adhesive or the like.

Here, as a ventilation structure for causing the accommodation space S to be ventilated to the outside, the lower sealing member 62 includes a mesh structure that inhibits entry and exit of water and oil and that allows entry and exit of gas. The mesh structure has micropores penetrating the lower sealing member 62. The lower sealing member 62 of Embodiment 1 is composed of a constituting member including a mesh structure, and an example of such a constituting member is TEMISH (registered trademark). Since the lower sealing member 62 includes the mesh structure, a liquid or a solid cannot pass through the lower sealing member 62 and only gas can pass through the lower sealing member 62. Accordingly, the air pressure in the accommodation space S becomes approximately equal to the outside air pressure.

The entirety of the lower sealing member 62 need not necessarily be composed of a constituting member including the mesh structure, and the lower sealing member 62 may be composed of a constituting member partially including the mesh structure. For example, the lower sealing member 62 may be mainly composed of a constituting member that is airtight, and an opening formed in a portion of this constituting member may be closed by a constituting member including the mesh structure. Alternatively, the lower sealing member 62 may be formed by joining a constituting member that is airtight and a constituting member including the mesh structure.

Thus, the load detecting device 2 is completed. Then, the cable 70 is connected to the external detection circuit, and the load applied to the upper face 11b of the load sensor 1 via the upper sealing member 61 is detected.

### <Effects of Embodiment 1>

According to Embodiment 1, the following effects are exhibited.

The sealing member 60 includes an air pressure adjustment structure for causing the air pressure in the accommodation space S of the load sensor 1 formed by the lower sealing member 62 and the upper sealing member 61 to be approximately equal to the outside air pressure. In Embodiment 1, this air pressure adjustment structure includes a ventilation structure that causes the accommodation space S to be ventilated to the outside. More specifically, this ventilation structure includes a mesh structure that inhibits entry and exit of water and oil and that allows entry and exit of gas.

In this configuration, since the load sensor 1 is encapsulated in the sealing member 60, water or oil, foreign matter, or the like is less likely to enter the gap between the upper substrate 11 and the lower substrate 21. Therefore, deterioration of characteristics of the load sensor 1 due to entry of these can be prevented. Since the air pressure in the accommodation space S of the load sensor 1 becomes approximately equal to the outside air pressure due to the air pressure adjustment structure, decrease in the detection accuracy due to the air pressure difference between the accommodation space S and the outside can be suppressed. Therefore, the applied load can be accurately detected.

As described above, the air pressure adjustment structure includes the ventilation structure that causes the accommodation space S to be ventilated to the outside. Therefore, the air pressure in the accommodation space S can be easily maintained in a state of being approximately equal to the outside air pressure. Further, this ventilation structure includes a mesh structure that inhibits entry and exit of water and oil and that allows entry and exit of gas. Therefore, while entry of water or oil into a space between the upper substrate 11 and the lower substrate 21 is prevented, the air pressure in the accommodation space S can be maintained in a state of being approximately equal to the outside air pressure.

The mesh structure included in the sealing member 60 is formed in the lower sealing member 62. The mesh structure is likely to have a high rigidity due to the structure thereof. Meanwhile, since the upper sealing member 61 is a member that receives a load, it is preferable that the upper sealing member 61 is as soft as possible in order to appropriately transmit the applied load to the upper substrate 11 of the load sensor 1. On the other hand, in order for the lower sealing member 62 to support the joined upper sealing member 61 in a desired state, it is preferable that the lower sealing member 62 has a rigidity as high as possible. Therefore, when the mesh structure, which is likely to have a high rigidity, is formed in the lower sealing member 62, the upper sealing member 61 can be supported in a desired state by the lower sealing member 62, while the softness of the upper sealing member 61 is maintained, thereby enhancing the load detection accuracy.

The load sensor 1 is encapsulated in the sealing member 60 such that the upper sealing member 61 is in close contact with the upper face 11b of the upper substrate 11. In the upper sealing member 61, a difference can be caused, although slightly, in softness depending on the position. Therefore, if displacement of the upper sealing member 61 with respect to the upper substrate 11 occurs, distribution of softness of the upper sealing member 61 with respect to the upper substrate 11 changes, and load detection sensitivity at each element part A11 to A33 can vary. Thus, there is a risk that the stability of load detection in the same element part A1 slightly decreases. In contrast, in the above configuration, displacement of the upper sealing member 61 with respect to the upper substrate 11 can be suppressed. Therefore, variation in the load detection sensitivity in the element parts A11 to A33 can be suppressed, and the load can be stably detected.

The lower sealing member 62 has a higher rigidity than the upper sealing member 61. In this configuration, the upper sealing member 61 joined to the lower sealing member 62 can be supported in a desired state by the lower sealing member 62. Accordingly, for example, the upper sealing member 61 can appropriately maintain the state of being in close contact with the upper face 11b of the upper substrate 11, and displacement of the upper sealing member 61 with respect to the upper substrate 11 can be suppressed. Therefore, the load can be stably detected. When the rigidity of the lower sealing member 62 is relatively high, it is possible to prevent the load applied to the load detecting device 2 from escaping to the surroundings via the lower substrate 21, and thus, the load can be appropriately detected. Further, since the shape in a plan view of the load detecting device 2 is maintained, a situation where the upper substrate 11 and the lower substrate 21 are broken to be damaged can be avoided.

### <Modification of Embodiment 1>

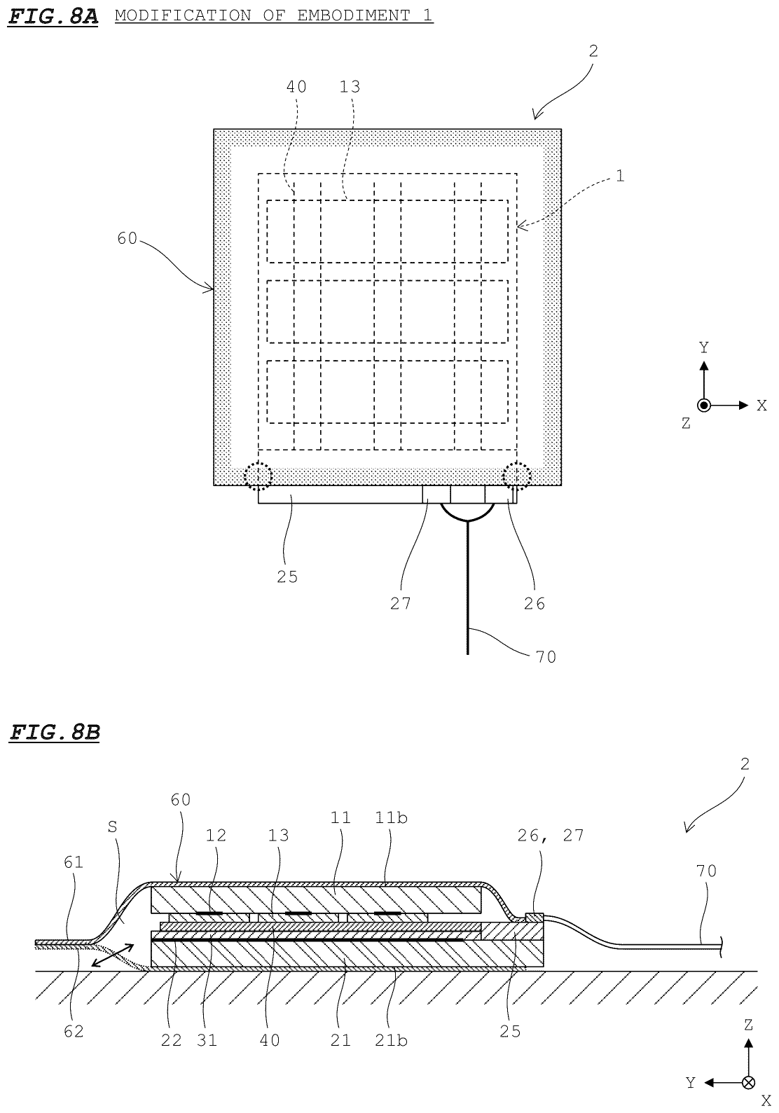

In Embodiment 1, the upper sealing member 61 and the lower sealing member 62 are joined together such that the sealing member 60 completely accommodates the load sensor 1. However, as long as the accommodation space S that covers the gap between the upper substrate 11 and the lower substrate 21 is formed, the sealing member 60 need not necessarily completely accommodate the load sensor 1, as shown in FIGS. 8A, 8B, for example.

FIGS. 8A, 8B are respectively a plan view and a cross-sectional view schematically showing a configuration of the load detecting device 2 according to a modification of Embodiment 1.

In the present modification, as compared with Embodiment 1, end portions on the Y-axis negative side of the upper sealing member 61 and the lower sealing member 62 are disposed at the position of the substrate 25 in the Y-axis direction. The upper face of the substrate 25 has an approximately planar shape. The end portion on the Y-axis negative side of the upper sealing member 61 is positioned between an end portion on the Y-axis positive side of the upper face of the substrate 25 and end portions on the Y-axis positive side of the connectors 26, 27, and is joined to the upper face of the substrate 25 with an adhesive or the like. The end portion on the Y-axis negative side of the lower sealing member 62 is positioned at the lower face of the lower substrate 21 positioned below the substrate 25, and is joined to the lower face of the substrate 21 with an adhesive or the like.

The upper sealing member 61 and the lower sealing member 62 other than the portions overlapping with the substrate 25 are joined to each other at outer edge portions thereof, as in Embodiment 1. At this time, the inner faces of the upper sealing member 61 and the lower sealing member 62 at the position indicated by dotted lines in FIG. 8A are joined to side faces of the substrate 25 and the lower substrate 21 with an adhesive.

Since the upper sealing member 61 and the lower sealing member 62 are joined together as shown in FIGS. 8A, 8B, the sealing member 60 encapsulates the load sensor 1, as in Embodiment 1. The accommodation space S of the load sensor 1 is formed by the upper sealing member 61 and the lower sealing member 62, as in Embodiment 1.

In the present modification as well, since the load sensor 1 is encapsulated in the sealing member 60, water or oil, foreign matter, or the like is less likely to enter the gap between the upper substrate 11 and the lower substrate 21. Therefore, deterioration of characteristics of the load sensor 1 due to entry of these can be prevented. Since the air pressure in the accommodation space S of the load sensor 1 becomes approximately equal to the outside air pressure due to the mesh structure of the lower sealing member 62, decrease in the detection accuracy due to the air pressure difference between the accommodation space S and the outside can be suppressed. Therefore, the applied load can be accurately detected. Since the connectors 26, 27 are in a state of being exposed to the outside, attachment and detachment of the cable 70 can be easily performed.

The method for setting the sealing member 60 as described above may be applied to embodiments and modifications other than the present modification.

### Embodiment 2

In Embodiment 1, the lower sealing member 62 includes the mesh structure, whereby the air pressure in the accommodation space S of the load sensor 1 is caused to be approximately equal to the outside air pressure. In contrast, in Embodiment 2, the air pressure in the accommodation space S is caused to be approximately equal to the outside air pressure by a ventilation hole provided to the sealing member 60.

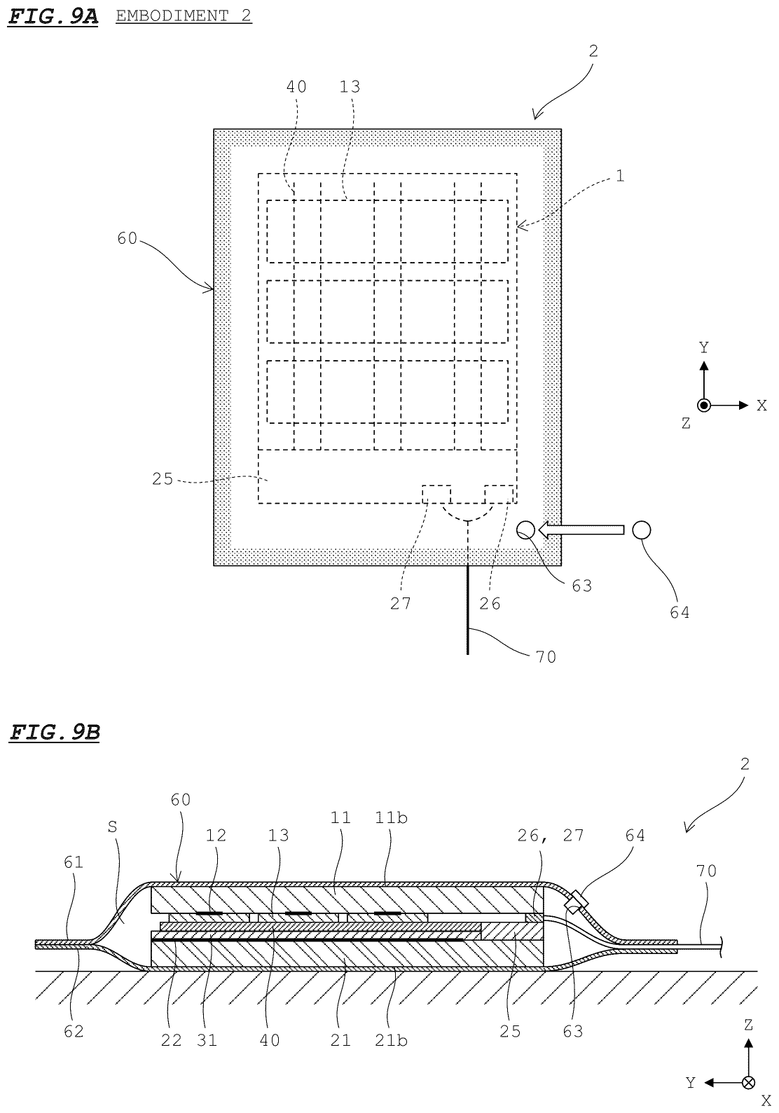

FIGS. 9A, 9B are respectively a plan view and a cross-sectional view schematically showing a configuration of the load detecting device 2 according to Embodiment 2.

In Embodiment 2, as compared with Embodiment 1 in FIGS. 7A, 7B, the lower sealing member 62 does not include the mesh structure and is composed of a constituting member that is airtight. Near the outer edge of the upper sealing member 61, a ventilation hole 63 penetrating the upper sealing member 61 is formed, and to the ventilation hole 63, a cap 64 for hermetically sealing the ventilation hole 63 is set so as to be removable from the ventilation hole 63. The cap 64 is a cap that can open the ventilation hole 63 stepwise according to the rotation degree with respect to the ventilation hole 63, and is a so-called screw cap. When the upper sealing member 61 and the lower sealing member 62 are joined together as in Embodiment 1, the load sensor 1 is encapsulated inside the sealing member 60, and the accommodation space S of the load sensor 1 is formed. The accommodation space S in this case is in a state of being blocked from the outside when the cap 64 is set.

According to Embodiment 2, as the ventilation structure that causes the accommodation space S in which the load sensor 1 is encapsulated to be ventilated to the outside, the ventilation hole 63 formed on the outer side of the load sensor 1 in a plan view is provided. In this configuration, when the cap 64 is loosened during use of the load detecting device 2, the air pressure in the accommodation space S can be easily maintained in a state of being approximately equal to the outside air pressure via the ventilation hole 63, while a state where entry of water, dirt, or the like is less likely to occur is maintained. Since the ventilation hole 63 is formed on the outer side of the load sensor 1 in a plan view, should water or oil, foreign matter, or the like enter through the ventilation hole 63, these are less likely to enter the gap between the upper substrate 11 and the lower substrate 21. Therefore, deterioration of characteristics of the load sensor 1 can be appropriately suppressed.

The position of the ventilation hole 63 is not limited to the position shown in FIG. 9A. However, in order to suppress entry of foreign matter into the load sensor 1 through the ventilation hole 63 during use of the load detecting device 2, it is preferable that the ventilation hole 63 is provided at a position that does not overlap with the load sensor 1 in a plan view, and it is more preferable that the ventilation hole 63 is separated as much as possible from the outer edge of the load sensor 1 in the outward direction.

### <Modification of Embodiment 2>

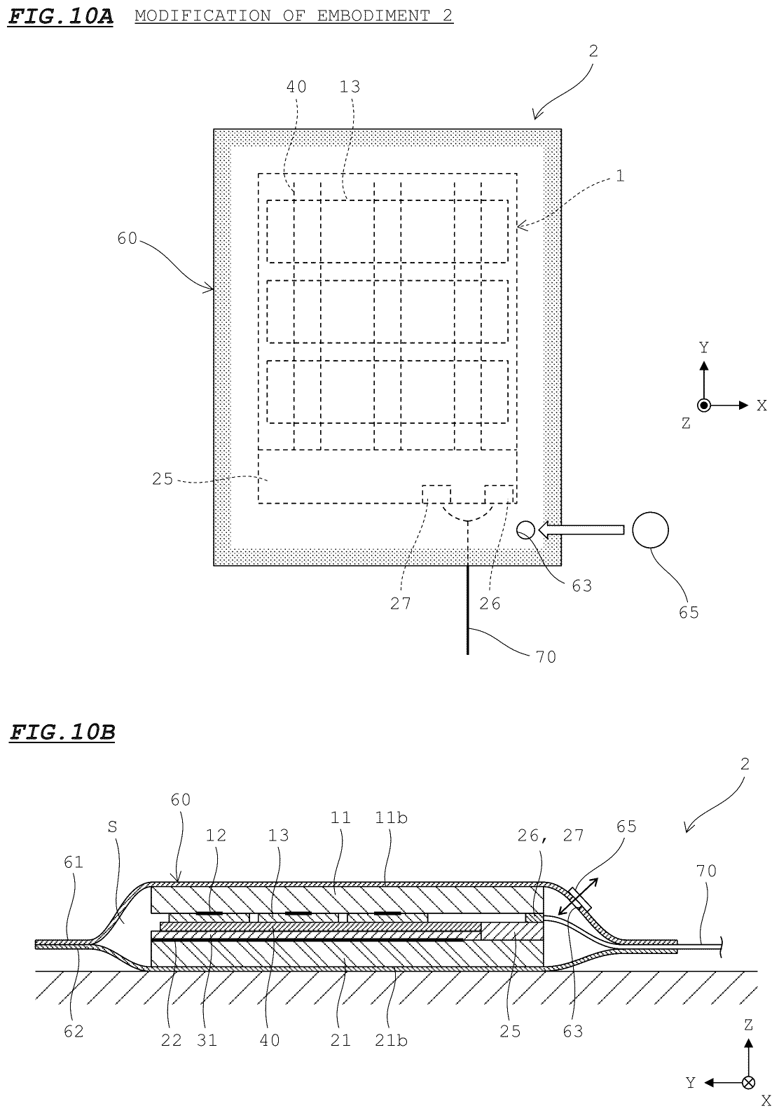

In Embodiment 2, the ventilation hole 63 is made open during use of the load detecting device 2. However, the ventilation hole 63 need not necessarily be made open during use of the load detecting device 2, and may always be in a state of being open. In this case, as shown in FIGS. 10A, 10B, it is preferable that a filter 65 is provided to the ventilation hole 63.

FIGS. 10A, 10B are respectively a plan view and a cross-sectional view schematically showing a configuration of the load detecting device 2 according to a modification of Embodiment 2.

In the present modification, as compared with Embodiment 2 in FIGS. 9A, 9B, the filter 65 is set to the ventilation hole 63. The other configurations are the same as those in Embodiment 2. The filter 65 includes micropores that inhibit entry and exit of water and oil and that allow entry and exit of gas. The micropores of the filter 65 may be micropores of a level that is less likely to allow passage of dust and the like.

According to the present modification, without operating the cap 64 as in Embodiment 2, the air pressure in the accommodation space S can be easily maintained in a state of being approximately equal to the outside air pressure via the ventilation hole 63 and the filter 65 (ventilation hole). Since the filter 65 is provided to the ventilation hole 63, entry of water or oil, foreign matter, or the like through the ventilation hole 63 can be prevented.

The ventilation hole 63 above may be formed in the upper sealing member 61 of Embodiment 1 and the modification of Embodiment 1.

### Embodiment 3

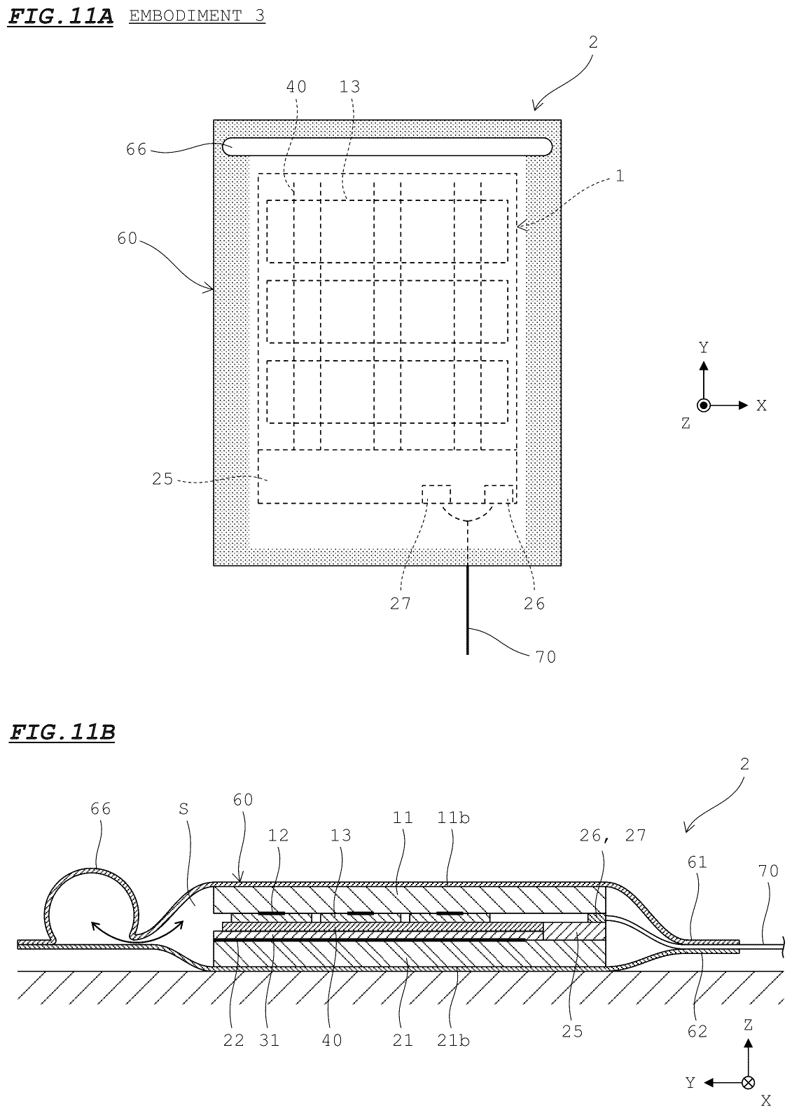

In Embodiment 3, as a structure for adjusting the air pressure in the accommodation space S of the load sensor 1, a slack part 66 is formed in the sealing member 60, as shown in FIGS. 11A, 11B.

FIGS. 11A, 11B are respectively a plan view and a cross-sectional view schematically showing a configuration of the load detecting device 2 according to Embodiment 3.

In Embodiment 3, as compared with Embodiment 2 in FIGS. 9A, 9B, in the upper sealing member 61, the slack part 66 is formed instead of the ventilation hole 63. The slack part 66 is formed on the outer side of the Y-axis positive direction of the load sensor 1 in a plan view. The slack part 66 has a shape largely bulged in the Z-axis positive direction. The capacity of the slack part 66 changes in accordance with a difference between the air pressure in the accommodation space S and the outside air pressure. The upper sealing member 61 other than the slack part 66 is affixed in a state of being in close contact with the upper face 11b of the upper substrate 11, with an adhesive or the like.

The slack part 66 has a lower rigidity than the upper sealing member 61 other than the slack part 66. As a configuration for reducing the rigidity of the slack part 66, the thickness of the slack part 66 is made smaller than the thickness of the upper sealing member 61 other than the slack part 66, for example. In order to change the thickness of the slack part 66, the number of layers of film-shaped sheets forming the slack part 66 may be changed, or the thickness may be changed by film shaping. The material forming the slack part 66 may be a material having a smaller elastic modulus than the material forming the upper sealing member 61 other than the slack part 66. In this case, for example, after the portion of the upper sealing member 61 other than the slack part 66 has been formed, a material, as the slack part 66, having a lower elastic modulus than this portion is affixed to this portion with an adhesive or by heat welding, whereby the upper sealing member 61 may be formed. As the slack part 66, a rubber material or the like can be used, for example.

The slack part 66 need not necessarily be provided on the outer side in the Y-axis positive direction of the load sensor 1, may be provided on the outer side of another side of the load sensor 1, or may be provided on the outer side of four sides of the load sensor 1. The shape in a plan view of the slack part 66 is not limited to a shape that is long in one direction, and may be a circular or rectangular shape.

According to Embodiment 3, as the air pressure adjustment structure, the slack part 66 whose capacity changes in accordance with a difference between the air pressure in the accommodation space S and the outside air pressure is formed. In this configuration, in accordance with the air pressure difference between the air pressure in the accommodation space S and the outside air pressure, the volume of the accommodation space S including the slack part 66 changes, whereby the air pressure difference is eliminated. Therefore, the air pressure in the accommodation space S can be easily maintained in a state of being approximately equal to the outside air pressure.

The slack part 66 is formed in the upper sealing member 61. Since the slack part 66 is formed in the upper sealing member 61 which is preferably soft, the slack part 66 can be made soft. Therefore, the slack part 66 can be easily deformed in accordance with the air pressure difference between the air pressure in the accommodation space S and the outside air pressure, and the volume of the accommodation space S including the slack part 66 can be smoothly changed into a state where the air pressure difference is eliminated.

The slack part 66 is configured to be more likely to be deformed than the portion, of the upper sealing member 61, where the slack part 66 is not formed. In this configuration, the slack part 66 is mainly deformed in accordance with the air pressure difference between the air pressure in the accommodation space S and the outside air pressure. Accordingly, displacement of the upper sealing member 61 other than the slack part 66 with respect to the upper substrate 11 due to the air pressure difference can be suppressed. Therefore, the load can be stably detected.

Although the upper sealing member 61 is formed so as to be as homogeneous as possible, unevenness occurs in the distribution of softness. Therefore, if the upper sealing member 61 is displaced with respect to the upper substrate 11 due to the air pressure difference, the distribution of softness of the upper sealing member 61 with respect to the upper substrate 11 changes, and the characteristic of load detection in the same element part A1 changes. Thus, there is a risk that the stability of load detection in the same element part A1 slightly decreases. In contrast, in the above configuration, displacement of the upper sealing member 61 other than the slack part 66 with respect to the upper substrate 11 due to the air pressure difference can be suppressed. Therefore, the load can be stably detected in the same element part A1.

The upper sealing member 61 is affixed to the upper face 11b of the upper substrate 11. In this configuration, even when the volume of the accommodation space S including the slack part 66 has changed due to the air pressure difference between the air pressure in the accommodation space S and the outside air pressure, the upper sealing member 61 is not displaced with respect to the upper substrate 11. Therefore, the load can be stably detected.

In the above configuration, the rigidity of the slack part 66 is configured to be lower than the rigidity of the portion of the upper sealing member 61 other than the slack part 66. However, as long as the slack part 66 can be smoothly deformed in accordance with the air pressure difference between the air pressure in the accommodation space S and the outside air pressure, the rigidity of the slack part 66 need not necessarily be lower than the rigidity of the portion of the upper sealing member 61 other than the slack part 66.

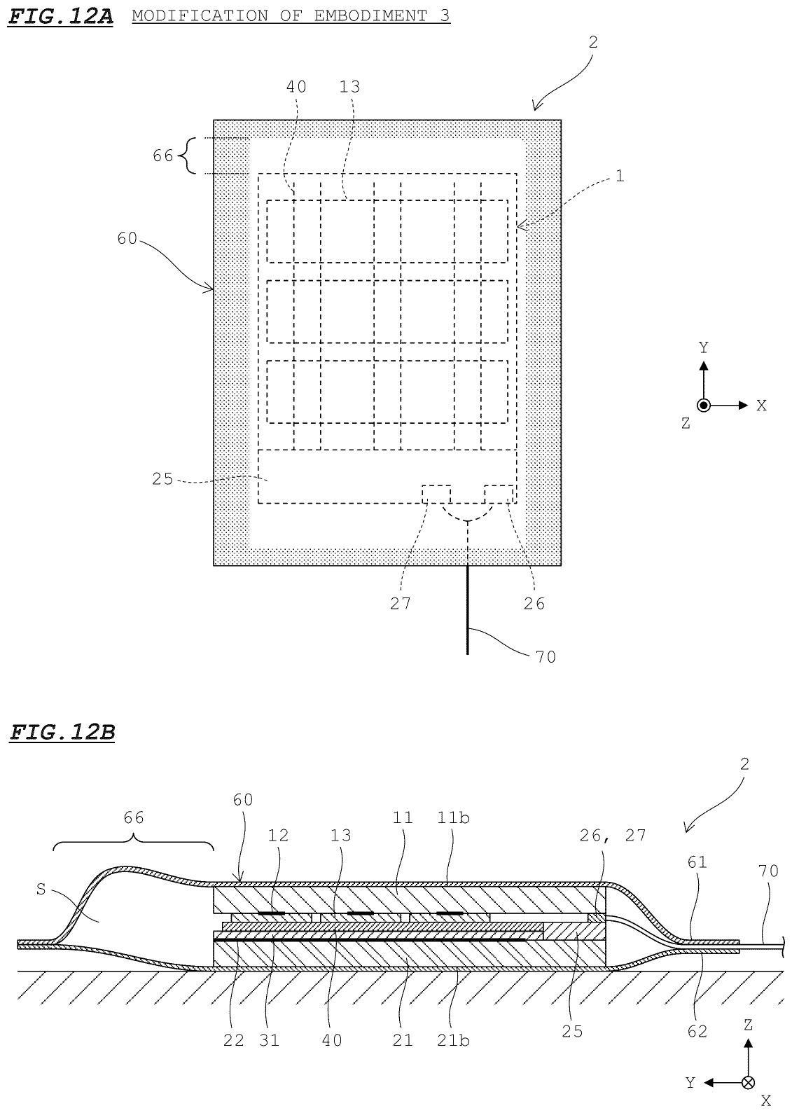

In the configuration in FIGS. 11A, 11B, the slack part 66 and the portion of the upper sealing member 61 other than the slack part 66 are clearly divided. However, as shown in FIGS. 12A, 12B, the slack part 66 may be formed by the upper sealing member 61 being joined, in a slack state with room, to the lower sealing member 62. In this case, the entirety of the upper sealing member 61 including the slack part 66 may be uniformly formed by a material having the same rigidity.

### Embodiment 4

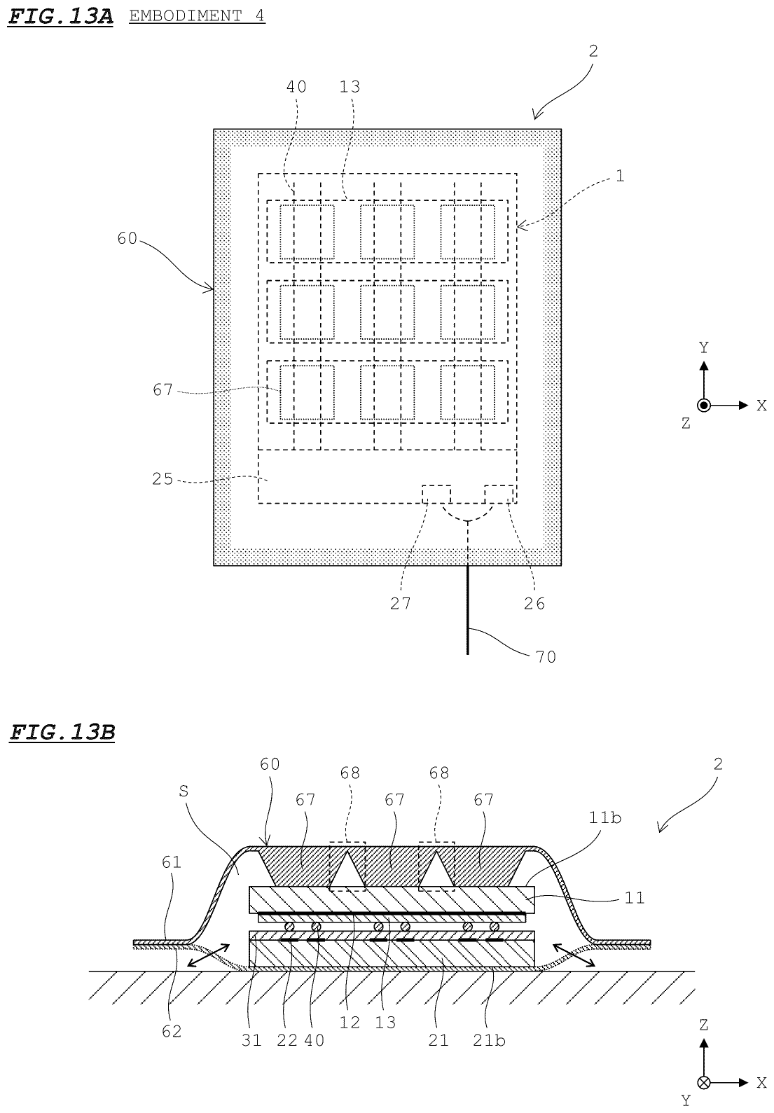

In Embodiments 1 to 3, the upper sealing member 61 is formed in a sheet shape. In contrast, in Embodiment 4, as shown in FIGS. 13A, 13B, pressure-receiving parts 67 are provided to the lower face of the upper sealing member 61.

FIGS. 13A, 13B are respectively a plan view and a cross-sectional view schematically showing a configuration of the load detecting device 2 according to Embodiment 4.

In Embodiment 4, as compared with Embodiment 1 in FIGS. 7A, 7B, the upper sealing member 61 has: a plurality of pressure-receiving parts 67 disposed at positions respectively corresponding to the plurality of element parts A1; and thin parts 68 formed between the pressure-receiving parts 67 adjacent to each other. The thickness of each pressure-receiving part 67 is larger than the thickness of the outer edge portion of the upper sealing member 61, and the pressure-receiving part 67 protrudes from the lower face of the upper sealing member 61 in the Z-axis negative direction. Each thin part 68 is thinnest at the center in the width direction thereof, and becomes gradually thinner from both ends thereof toward the center in the width direction.

According to Embodiment 4, the load applied to each pressure-receiving part 67 is efficiently transmitted to the element part A1 corresponding to the pressure-receiving part 67. Therefore, the load applied to the upper face (the upper face of the upper sealing member 61) of the load detecting device 2 can be accurately detected.

The configuration of the upper sealing member 61 as above may be applied to embodiments and modifications other than the present embodiment.

### <Modification of Embodiment 4>

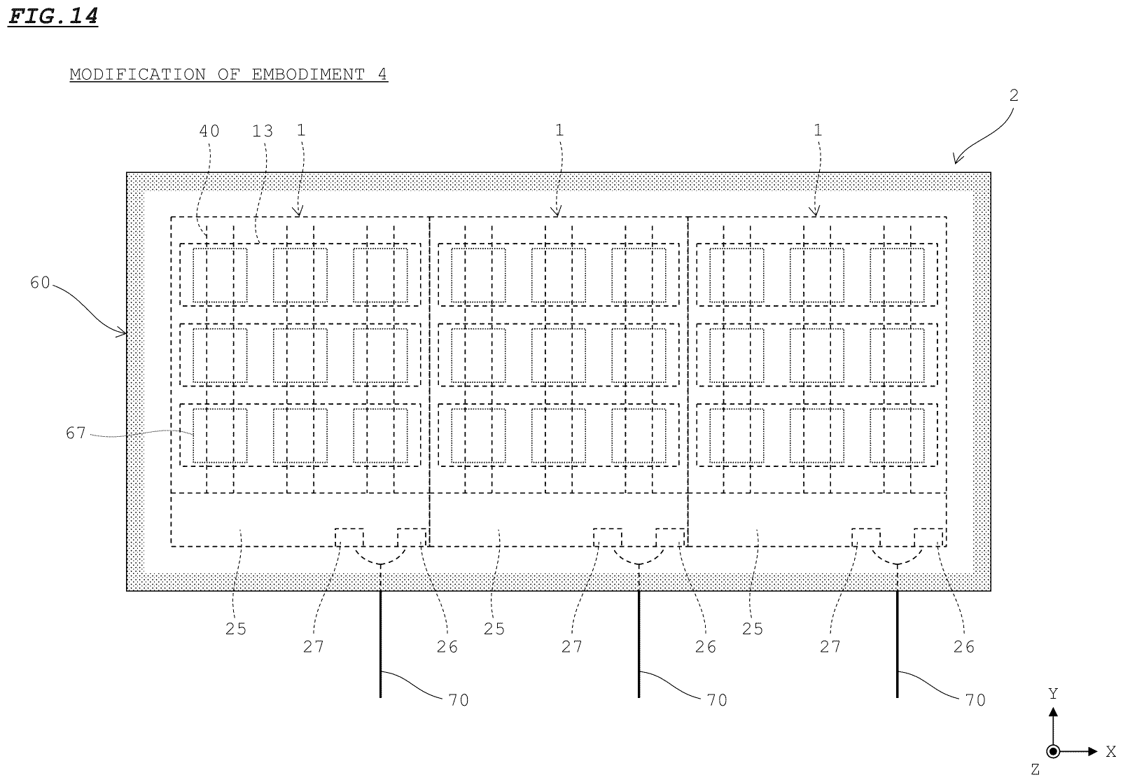

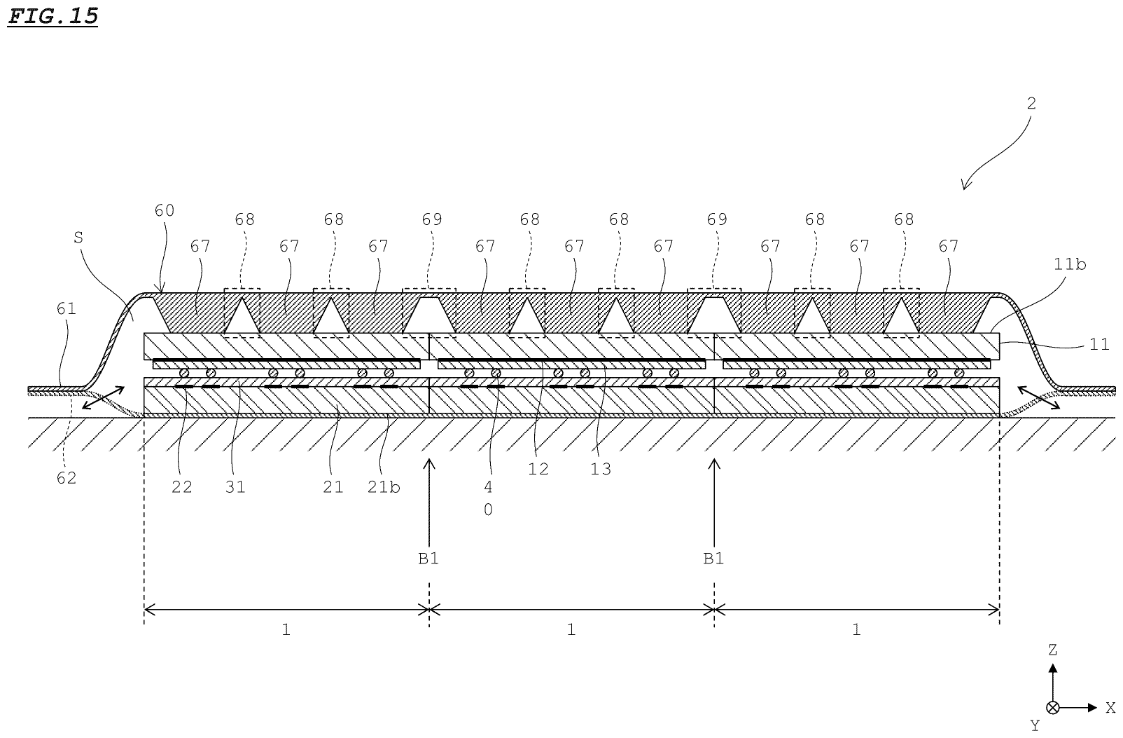

In Embodiment 4, one load sensor 1 is encapsulated in the sealing member 60, but not limited thereto, a plurality of the load sensors 1 may be encapsulated in the sealing member 60. For example, as shown in FIGS. 14, 15, three load sensors 1 may be encapsulated in one sealing member 60.

FIG. 14 is a plan view schematically showing a configuration of the load detecting device 2 according to a modification of Embodiment 4.

In the present modification, three load sensors 1 similar to that in the above embodiment are disposed so as to be adjacent to each other in the X-axis direction, and the three load sensors 1 are encapsulated in one sealing member 60. The sealing member 60 has a shape that is long in the X-axis direction so as to be able to accommodate the three load sensors 1. Three cables 70 respectively connected to the three load sensors 1 are each drawn out from between the upper sealing member 61 and the lower sealing member 62. The three cables 70 may be combined into one in the sealing member 60, and the combined cables 70 may be drawn out from the sealing member 60 at one location.

FIG. 15 is a cross-sectional view schematically showing a configuration of the load detecting device 2 according to the modification of Embodiment 4.

Two load sensors 1 adjacent to each other are disposed such that the upper substrates 11 are in contact with each other and the lower substrates 21 are in contact with each other. In order to prevent the position of each load sensor 1 from being shifted in the horizontal direction, the lower face 21b of the lower substrate 21 of each load sensor 1 may be affixed to the upper face of the lower sealing member 62 with an adhesive, or one substrate may be disposed between the lower substrates 21 and the lower sealing member 62 so as to extend across the three lower faces 21b, for example.

The sealing member 60 includes: the pressure-receiving parts 67 and the thin parts 68 similar to those in Embodiment 4; and thin parts 69 each formed so as to extend across a boundary B1 between the load sensors 1 adjacent to each other. Each thin part 69 is thinnest at the center in the width direction thereof, and becomes gradually thinner from both ends thereof toward the vicinity of the center. Since the thin part 69 extending across the boundary B1 between the load sensors 1 adjacent to each other is formed as shown in FIG. 15, when a load is applied to the boundary B1 as well, this load can be appropriately transmitted to the element part A1 adjacent to the boundary B1.

The constituting member forming the sealing member 60 of the present modification is the same as that in Embodiment 1, and the lower sealing member 62 includes a mesh structure. Each pressure-receiving part 67 of the upper sealing member 61 is disposed so as to be in close contact with the upper face (the upper face 11b of the upper substrate 11) of the load sensor 1.

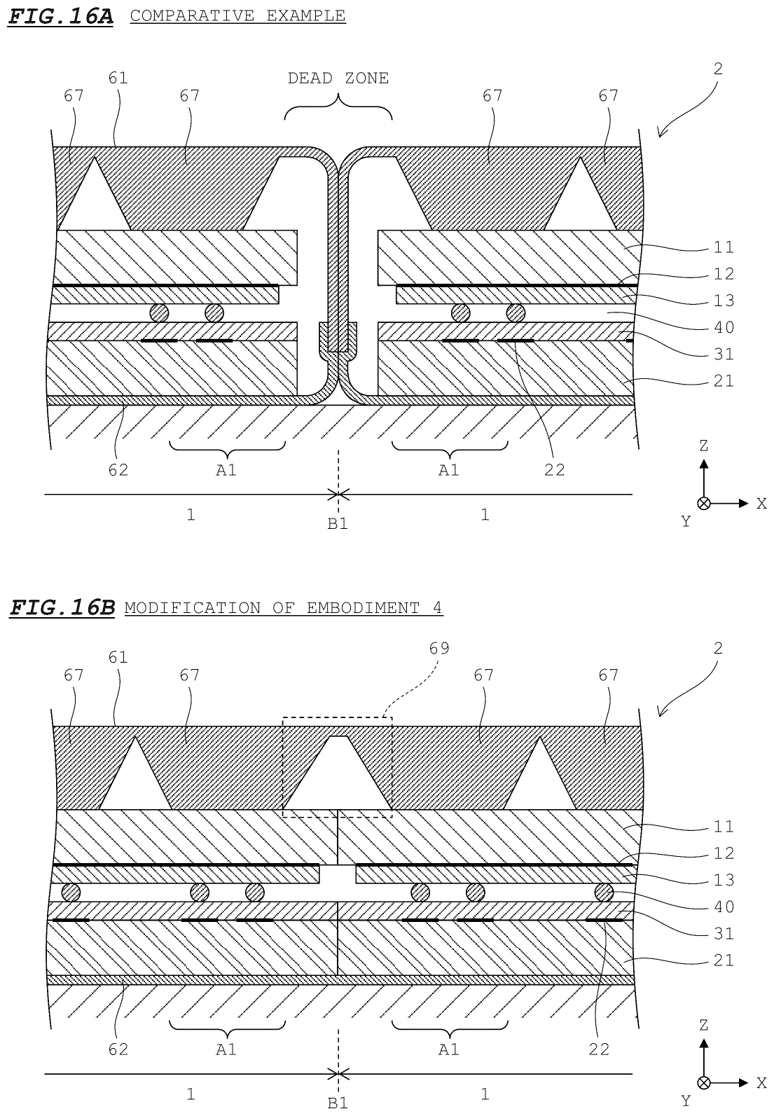

Effects of the configuration of the thin part 69 formed at the boundary B1 will be described with reference to FIGS. 16A, 16B.

FIG. 16A is a cross-sectional view schematically showing a configuration of the load detecting device 2 in the vicinity of the boundary B1 according to Comparative Example.

In Comparative Example, three load detecting devices 2 of Embodiment 4 shown in FIGS. 13A, 13B are arranged so as to be adjacent in the X-axis direction. In this case, in the vicinity of the boundary B1 between the load sensors 1 adjacent to each other, a region where no load can be detected, i.e., a so-called dead zone, is caused.

FIG. 16B is a cross-sectional view schematically showing a configuration of the load detecting device 2 in the vicinity of the boundary B1 according to the modification of Embodiment 4.

In the present modification, at the boundary B1 between the load sensors 1 adjacent to each other, a thin part 69 is formed. As described above, the thin part 69 is thinnest at the center in the width direction thereof and becomes gradually thinner from both ends thereof toward the vicinity of the center. Accordingly, the load applied to the boundary B1 between the load sensors 1 adjacent to each other is transmitted to the element part A1 adjacent to the boundary B1. Therefore, this load can be appropriately detected.

According to the modification of Embodiment 4, the following effects are exhibited.

As shown in FIG. 14, a plurality of the load sensors 1 are encapsulated in one sealing member 60. In this configuration, as compared with a case where a plurality of the load sensors 1 are individually sealed, the sealing work can be facilitated. When a plurality of the load sensors 1 are individually sealed and arranged, the sealing member 60 is sandwiched between the load sensors 1 adjacent to each other, and thus, the dead space where no load can be detected becomes large. In contrast, in the above configuration, since a plurality of the load sensors 1 are encapsulated in one sealing member 60, the sealing member 60 is not sandwiched between the load sensors 1 adjacent to each other as shown in FIG. 16B. Therefore, the dead space at the boundary B1 between the load sensors 1 can be suppressed.

In each load sensor 1, a plurality of the electrically-conductive elastic bodies 13 and a plurality of the electrically-conductive members 41 (linear electrically-conductive member) are disposed such that the element parts A1 for load detection formed by crossing of the electrically-conductive elastic bodies 13 and the electrically-conductive members 41 (linear electrically-conductive members) are arranged in the X-axis direction (first direction) and the Y-axis direction (second direction) in a plan view. A plurality of the load sensors 1 are encapsulated in the sealing member 60 so as to be adjacent to each other in the X-axis direction (first direction). The upper sealing member 61 has: a plurality of the pressure-receiving parts 67 disposed at positions respectively corresponding to the plurality of element parts A1; and the thin parts 68, 69 formed between the pressure-receiving parts 67 adjacent to each other. The thin part 69 positioned at the boundary B1 between the load sensors 1 adjacent to each other is formed so as to extend across the boundary B1. In this configuration, the dead space at the boundary B1 between the load sensors 1 adjacent to each other can be further suppressed. That is, as shown in FIG. 16B, the pressure-receiving part 67 can be disposed also in the vicinity of this boundary B1, and the load applied to this pressure-receiving part 67 can be transmitted to the corresponding element part A1.

The thin part 68, 69 is thinnest at the center in the width direction thereof and becomes gradually thinner from both ends thereof toward the vicinity of the center. The width of the thin part 69 positioned at the boundary B1 is larger than the width of the other thin parts 68. In this configuration, the pressure-receiving part 67 in the vicinity of the boundary B1 between the load sensors 1 adjacent to each other can be made close to the boundary B1, and the load applied to this pressure-receiving part 67 can be efficiently transmitted to the element part A1 corresponding to this pressure-receiving part 67. Therefore, the dead space in the vicinity of this boundary B1 can be further suppressed, and as described with reference to FIG. 16B, the load applied to the vicinity of this boundary B1 can be more accurately detected.

The configuration in which a plurality of the load sensors 1 are encapsulated in one sealing member 60 as described above may be applied to embodiments and modifications other than the present modification.

### Embodiment 5

When a capacitance component (electromagnetic noise) comes close to the load detecting device 2, an error occurs in change in the potential that is measured, due to influence of the electromagnetic noise. Accordingly, the capacitance detection accuracy decreases. In contrast, in Embodiment 5, the load detecting device 2 is configured so as to block electromagnetic noise as shown below.

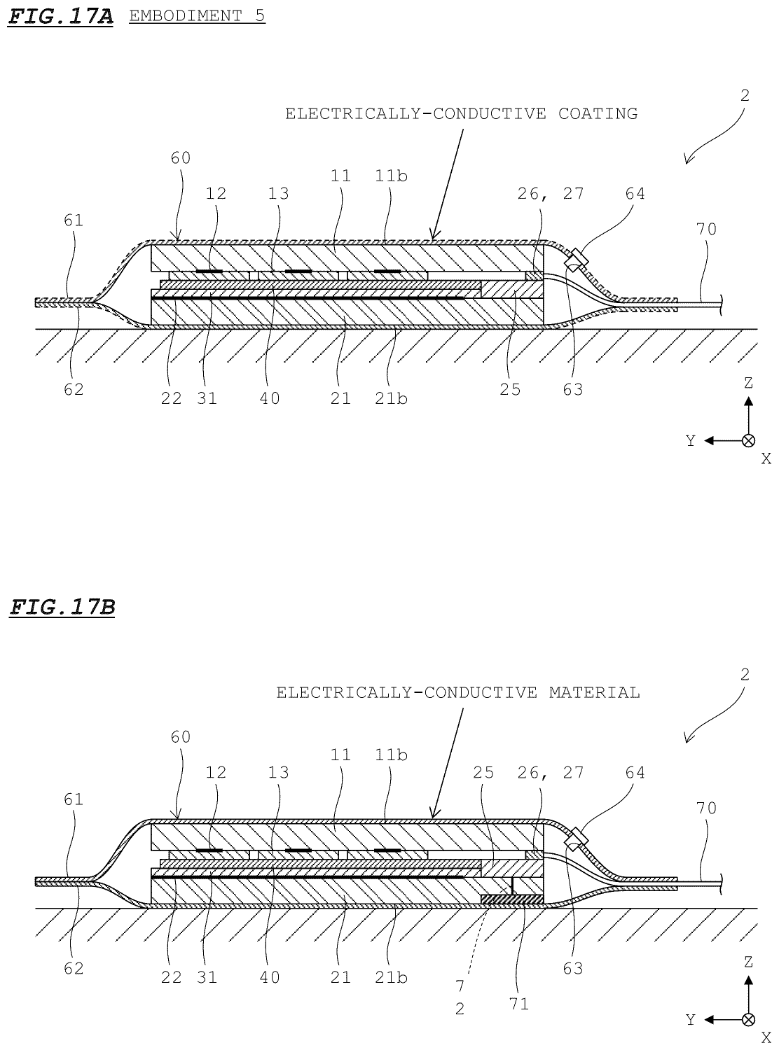

FIG. 17A is a cross-sectional view schematically showing the load detecting device 2 when an electrically-conductive coating is provided to the surface on the outer side of the sealing member 60 according to Embodiment 5. The electrically-conductive coating is indicated by a broken line, for convenience.

In this example, as compared with Embodiment 2, a thin film of a metal, etc., a surfactant layer, or the like is formed, as the electrically-conductive coating, on the surfaces on the outer side of the upper sealing member 61 and the lower sealing member 62 which are formed from an insulative material. The electrically-conductive coating is an electrically-conductive film (metal, metal oxide, electrically-conductive polymer, carbon), for example.

Thus, when electrical conductivity is added to the surface of the material of the sealing member 60, electromagnetic noise from outside can be blocked by the sealing member 60. Accordingly, the capacitance in the element part A1 can be accurately measured, and the load detection accuracy can be maintained at a high level.

In the configuration in FIG. 17A, an electrically-conductive coating may be provided to the surfaces on the inner side of the upper sealing member 61 and the lower sealing member 62.

Instead of providing an electrically-conductive coating to the surface of the sealing member 60, the sealing member 60 may be formed from an electrically-conductive material.

FIG. 17B is a cross-sectional view schematically showing the load detecting device 2 when the sealing member 60 is formed from an electrically-conductive material according to Embodiment 5.

In this example, as compared with Embodiment 2, the sealing member 60 is formed from a material having electrical conductivity or a material having a low insulation property. Alternatively, the sealing member 60 may be formed from a material obtained by mixing a substance having electrical conductivity to an insulative material similar to those in Embodiment 1.

In this case, an electrode 71 is set to the lower face 21b of the lower substrate 21 positioned below the substrate 25. The electrode 71 is connected to the lower end of a wire 72 penetrating the lower substrate 21 in the up-down direction, and the upper end of the wire 72 is connected to the connector 26 or 27 via the substrate 25. The terminal of the connector 26 or 27 to which the wire 72 is connected is connected to a specific potential of the external detection circuit via the cable 70. The specific potential may be the ground potential or may be a potential other than the ground potential.

When the load sensor 1 is set to the lower sealing member 62 during assembly, the electrode 71 is electrically connected to the lower sealing member 62. As described above, in this example, since the upper sealing member 61 and the lower sealing member 62 have electrical conductivity, the entirety of the sealing member 60 is connected to the specific potential via the electrode 71, the wire 72, and the cable 70.

Thus, when the sealing member 60 has electrical conductivity and the sealing member 60 is connected to the specific potential, the effect of electromagnetic shielding can be enhanced. Accordingly, electromagnetic noise from outside can be blocked by the sealing member 60. Therefore, the capacitance in the element part A1 can be accurately measured, and the load detection accuracy can be maintained at a high level.

In the configuration in FIG. 17B, the terminal connected to the specific potential of the connector 26 or 27 may be connected to the upper face of the lower sealing member 62 directly via a cable, not via the electrode 71, the wire 72, and the substrate 25. One end of the cable in this case is connected to the upper face of the lower sealing member 62 by soldering, for example.

According to Embodiment 5, the following effects are exhibited.

As shown in FIGS. 17A, 17B, at least one of the upper sealing member 61 and the lower sealing member 62 has electrical conductivity. In this configuration, electromagnetic noise from outside can be blocked by the sealing member 60. Therefore, decrease in the load detection accuracy due to electromagnetic noise can be suppressed.

As shown in FIG. 17B, the member that has electrical conductivity among the upper sealing member 61 and the lower sealing member 62 is electrically connected to the specific potential of the load sensor 1. In the example in FIG. 17B, both of the upper sealing member 61 and the lower sealing member 62 have electrical conductivity, and the entirety of the sealing member 60 is connected to the terminal connected to the specific potential of the connector 26 or 27, via the electrode 71, the wire 72, and the substrate 25. In this configuration, the effect of shielding electromagnetic noise can be enhanced. Therefore, decrease in the load detection accuracy due to electromagnetic noise can be further suppressed.

In FIGS. 17A, 17B, based on the configuration in Embodiment 2, an electrically-conductive coating is provided on the surface of the sealing member 60, or the sealing member 60 is formed from an electrically-conductive material. However, these additional configurations may be applied to embodiments and modifications other than Embodiment 2 above.

The configuration for blocking electromagnetic noise as above may be applied to embodiments and modifications other than the present embodiment.

<Other modifications>

In the above embodiments and modifications, in order to prevent ultraviolet light from being applied to the load sensor 1 in the accommodation space S, the sealing member 60 may include a configuration for preventing ultraviolet light. For example, the sealing member 60 is formed from a material that absorbs ultraviolet light so as not to allow ultraviolet light to be transmitted therethrough. An example of such a material is a macromolecular polymer. A material that scatters and reflects ultraviolet light may be disposed on the surface of the sealing member 60. An example of such a material is inorganic oxide particles such as titanium oxide. The configuration for preventing ultraviolet light may be provided at least to the upper sealing member 61.

When ultraviolet light is applied to the load sensor 1, the rubber material (e.g., the electrically-conductive elastic bodies 13) forming the load sensor 1 is deteriorated, and the load cannot be accurately detected. In contrast, when the configuration for preventing entry of ultraviolet light into the accommodation space S is provided as described above, deterioration of the rubber material forming the load sensor 1 is suppressed, and the load detection accuracy can be maintained at a high level.

In the above embodiments and modifications, the upper sealing member 61 may have a region in which the hardness is different in a plan view. The difference in hardness is adjusted by the thickness of the upper sealing member 61, for example. Thus, when the region in which hardness is different is set in the upper sealing member 61, usage in which the load is mainly detected in a hard region and the load distribution is mainly detected in a soft region, is enabled, for example. Specifically, in a supermarket or the like, if a manager of a store places fruits and vegetables on a soft region, the manager can understand the amount of remaining commodities, and if a shopper places a commodity on a hard region, the shopper can weigh the commodity.

In the above embodiments and modifications, a QR code (registered trademark) may be printed on the upper face of the upper sealing member 61. Then, by reading the QR code (registered trademark), it becomes possible to individually identify the load detecting device 2.

In the above embodiments and modifications, a picture or characters may be printed on the upper face of the upper sealing member 61. For example, if a picture or characters indicating the kind of a commodity is printed on the upper face of the upper sealing member 61, it is possible to understand what kind of commodity should be placed on the region in which the picture or the characters are printed. When the picture or characters are to be changed, it is not necessary to replace the entirety of the load detecting device 2, and it is only necessary to replace the sealing member 60. Therefore, the picture or characters can be changed at low cost.

In the above embodiments and modifications, the upper sealing member 61 may be formed from a material having a high impact absorption property. For example, the upper sealing member 61 is formed from a viscoelastic material, i.e., a material that absorbs a large instantaneous force such as an impact force and that transmits a steady force such as the weight of a commodity. The upper sealing member 61 is formed from a silicone gel such as αGEL (registered trademark) manufactured by Taica Corporation, for example. Alternatively, the upper sealing member 61 may be a gel-like substance similar to a silicone gel or a soft (ultra-soft) elastomer, or may be formed from a styrene-based elastomer or a urethane-based elastomer. When the upper sealing member 61 is formed from these materials, even if a heavy commodity is dropped on the load detecting device 2, the impact of the drop is absorbed by the upper sealing member 61, and thus, damage of the load sensor 1 can be prevented.

In the above Embodiments 1, 2, 4, 5 and modifications of these, the upper sealing member 61 is disposed so as to be in close contact with the upper face (the upper face 11b of the upper substrate 11) of the load sensor 1, but may be affixed, in a state of being in close contact, to the upper face 11b of the upper substrate 11 with an adhesive or the like. In the above embodiments and modifications, the upper sealing member 61 and the lower sealing member 62 need not necessarily be joined together with an adhesive, and may be joined together by heat welding, for example.

In the above embodiments and modifications, as shown in FIGS. 1A, 1B, the load sensor 1 includes three sets each composed of an electrically-conductive elastic body 13 and an electrically-conductive part 12. However, the load sensor 1 may include at least one set composed of an electrically-conductive elastic body 13 and an electrically-conductive part 12. For example, the number of the above sets included in the load sensor 1 may be one.

In the above embodiments and modifications, as shown in FIG. 3A, the load sensor 1 includes three pairs of conductor wires 40, but may include at least one pair of conductor wires 40. For example, the number of pairs of conductor wires 40 included in the load sensor 1 may be one.

In the above embodiments and modifications, in the element part A1, two conductor wires 40 arranged in the X-axis direction are included. However, one or three or more conductor wires 40 may be included.

In the above embodiments and modifications, as shown in FIGS. 4A, 4B, the conductor wire 40 is composed of one electrically-conductive member 41 and a dielectric body 42 covering this electrically-conductive member 41. However, not limited thereto, the conductor wire 40 may be implemented by a twisted wire obtained by bundling a plurality of conductor wires as above. The conductor wire 40 may be composed of a twisted wire obtained by bundling a plurality of electrically-conductive members and a dielectric body covering this twisted wire. In these cases, flexibility of the conductor wire 40 can be enhanced, and strength against bending of the conductor wire 40 can be enhanced.

In the above embodiments and modifications, the X-axis direction (first direction) in which the electrically-conductive elastic body 13 and the electrically-conductive part 12 extend and the Y-axis direction (second direction) in which the conductor wire 40 extends are orthogonal to each other. However, the first direction and the second direction need not necessarily cross each other at 90°.

In the above embodiments and modifications, the electrically-conductive part 12 and the electrically-conductive elastic body 13 are formed on the opposing face 11a of the upper substrate 11, but may be formed on the opposing face 21a of the lower substrate 21.

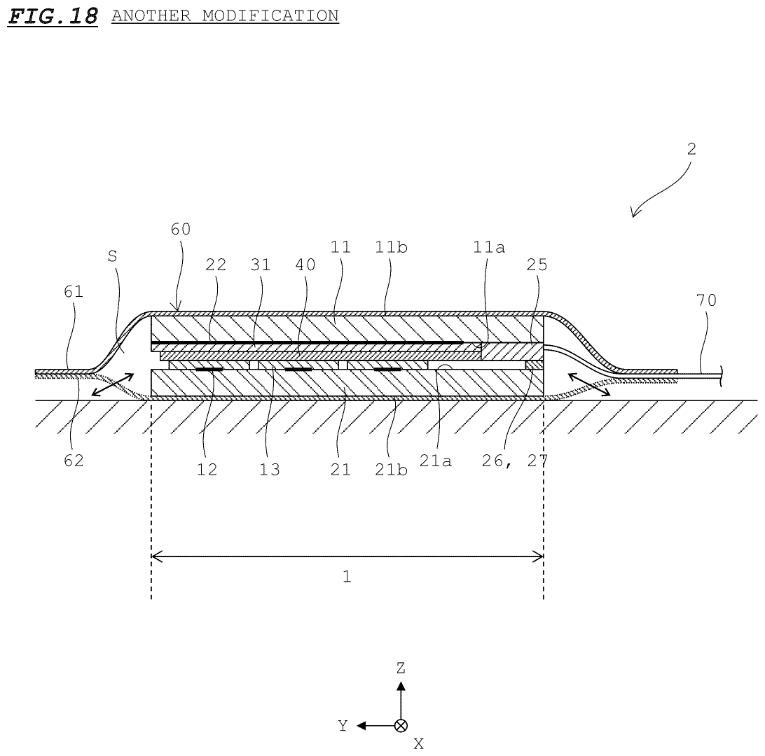

FIG. 18 is a cross-sectional view schematically showing a configuration of the load detecting device 2 in this case.

In the example shown in FIG. 18, as compared with Embodiment 1, the configurations between the upper substrate 11 and the lower substrate 21 of the load sensor 1 are disposed upside down. That is, the electric conductors 22, the wires 23, and the terminal parts 24 (see FIG. 2A), and the substrate 25 and the connectors 26, 27 are disposed on the opposing face 11a of the upper substrate 11, and the electrically-conductive parts 12 and the electrically-conductive elastic bodies 13 are formed on the opposing face 21a of the lower substrate 21. Then, the conductor wires 40 are disposed on the upper faces of the electrically-conductive elastic bodies 13, and the insulation film 31 is disposed between the conductor wires 40 and the upper substrate 11. In this case as well, the load applied to the upper face of the upper sealing member 61 can be detected by the load sensor 1.

The electrically-conductive parts 12 and the electrically-conductive elastic bodies 13 need not necessarily be formed on either one of the upper substrate 11 and the lower substrate 21, and may be formed on both of the opposing face 11a of the upper substrate 11 and the opposing face 21a of the lower substrate 21 so as to oppose each other.

In addition to the above, various modifications can be made as appropriate to the embodiments of the present invention without departing from the scope of the technical idea defined by the claims.

### (Additional Note)

The following technologies are disclosed by the description of the embodiments above.

### (Technology 1)

A load detecting device comprising:
a load sensor; and
a sealing member encapsulating the load sensor, wherein
the load sensor comprises
   an upper substrate having elasticity,
   a lower substrate disposed so as to oppose the upper substrate,
   at least one electrically-conductive elastic body formed on at least one of an opposing face of the upper substrate and an opposing face of the lower substrate,
   at least one linear electrically-conductive member disposed between the upper substrate and the lower substrate, and
   a dielectric body formed on an outer periphery of the linear electrically-conductive member, and
   the sealing member comprises
      a lower sealing member on which the load sensor is placed,
      an upper sealing member covering an upper face of the load sensor and joined to the lower sealing member, and
      an air pressure adjustment structure configured to cause an air pressure in an accommodation space, of the load sensor, formed by the lower sealing member and the upper sealing member to be approximately equal to an outside air pressure.

According to this technology, since the load sensor is encapsulated in the sealing member, water or oil, foreign matter, or the like is less likely to enter the gap between the upper substrate and the lower substrate. Therefore, deterioration of characteristics of the load sensor due to entry of these can be prevented. Since the air pressure in the accommodation space of the load sensor becomes approximately equal to the outside air pressure due to the air pressure adjustment structure, decrease in the detection accuracy due to the air pressure difference between the accommodation space and the outside can be suppressed. Therefore, the applied load can be accurately detected.

### (Technology 2)

The load detecting device according to technology 1, wherein
the air pressure adjustment structure includes a ventilation structure configured to cause the accommodation space to be ventilated to an outside.

According to this technology, the air pressure in the accommodation space can be easily maintained to be a state of being approximately equal to the outside air pressure.

### (Technology 3)

The load detecting device according to technology 2, wherein
the ventilation structure includes a mesh structure configured to inhibit entry and exit of water and oil and configured to allow entry and exit of gas.

According to this technology, while entry of water and oil into a space between the upper substrate and the lower substrate is prevented, the air pressure in the accommodation space can be maintained in a state of being approximately equal to the outside air pressure.

### (Technology 4)

The load detecting device according to technology 3, wherein
the mesh structure is formed in the lower sealing member.

The mesh structure is likely to have a high rigidity due to the structure thereof. Meanwhile, since the upper sealing member is a member that receives a load, it is preferable that the upper sealing member is as soft as possible in order to appropriately transmit the applied load to the upper substrate of the load sensor. On the other hand, in order for the lower sealing member to support the joined upper sealing member in a desired state, it is preferable that the lower sealing member has a rigidity as high as possible. Therefore, when the mesh structure, which is likely to have a high rigidity, is formed in the lower sealing member, the upper sealing member can be supported in a desired state by the lower sealing member, while the softness of the upper sealing member is maintained, thereby enhancing the load detection accuracy.

### (Technology 5)

The load detecting device according to any one of technologies 2 to 4, wherein
the ventilation structure includes a ventilation hole formed on an outer side of the load sensor in a plan view.

According to this technology, during use of the load detecting device, the air pressure in the accommodation space can be easily maintained in a state of being approximately equal to the outside air pressure via the ventilation hole. Since the ventilation hole is formed on the outer side of the load sensor in a plan view, should water or oil, foreign matter, or the like enter through the ventilation hole, these are less likely to enter the gap between the upper substrate and the lower substrate. Therefore, deterioration of characteristics of the load sensor can be appropriately suppressed.

### (Technology 6)

The load detecting device according to technology 1, wherein
the air pressure adjustment structure includes a slack part whose capacity changes in accordance with a difference between the air pressure in the accommodation space and the outside air pressure.

According to this technology, in accordance with the air pressure difference between the air pressure in the accommodation space and the outside air pressure, the volume of the accommodation space including the slack part changes, whereby the air pressure difference is eliminated. Therefore, the air pressure in the accommodation space can be easily maintained in a state of being approximately equal to the outside air pressure.

### (Technology 7)

The load detecting device according to technology 6, wherein
the slack part is formed in the upper sealing member.

Since the slack part is formed in the upper sealing member which is preferably soft, the slack part can be made soft. Therefore, according to this technology, the slack part can be easily deformed in accordance with the air pressure difference between the air pressure in the accommodation space and the outside air pressure, and the volume of the accommodation space including the slack part can be smoothly changed into a state where the air pressure difference is eliminated.

### (Technology 8)

The load detecting device according to technology 7, wherein
the slack part is configured to be more likely to be deformed than a portion, of the upper sealing member, where the slack part is not formed.

According to this technology, the slack part is mainly deformed in accordance with the air pressure difference between the air pressure in the accommodation space and the outside air pressure. Accordingly, displacement of the upper sealing member other than the slack part with respect to the upper substrate due to the air pressure difference can be suppressed. Therefore, the load can be stably detected.

### (Technology 9)

The load detecting device according to any one of technologies 6 to 8, wherein
the upper sealing member is affixed to an upper face of the upper substrate.

According to this technology, even when the volume of the accommodation space including the slack part has changed due to the air pressure difference between the air pressure in the accommodation space and the outside air pressure, the upper sealing member is not displaced with respect to the upper substrate. Therefore, the load can be stably detected.

### (Technology 10)

The load detecting device according to any one of technologies 1 to 9, wherein
a plurality of the load sensors are encapsulated in one said sealing member.

According to this technology, as compared with a case where a plurality of load sensors are individually sealed, the sealing work can be facilitated. When a plurality of load sensors are individually sealed and arranged, the sealing member is sandwiched between the load sensors adjacent to each other, and thus, the dead space where no load can be detected becomes large. In contrast, in the above technology, since a plurality of load sensors are encapsulated in one sealing member, the sealing member is not sandwiched between the load sensors adjacent to each other. Therefore, the dead space at the boundary between the load sensors can be suppressed.

### (Technology 11)

The load detecting device according to technology 10, wherein
in each of the load sensors, a plurality of the electrically-conductive elastic bodies and a plurality of the linear electrically-conductive members are disposed such that element parts for load detection formed by crossing of the electrically-conductive elastic bodies and the linear electrically-conductive members are arranged in a first direction and a second direction crossing the first direction in a plan view,
the plurality of load sensors are encapsulated in the sealing member so as to be adjacent to each other in the first direction,
the upper sealing member has: a plurality of pressure-receiving parts disposed at positions respectively corresponding to the plurality of element parts; and thin parts formed between the pressure-receiving parts adjacent to each other, and
the thin part that is positioned at a boundary between the load sensors adjacent to each other is formed so as to extend across the boundary.

According to this technology, the dead space at the boundary between the load sensors adjacent to each other can be further suppressed. That is, the pressure-receiving part can be disposed also in the vicinity of this boundary, and the load applied to this pressure-receiving part can be transmitted to the corresponding element part.

### (Technology 12)

The load detecting device according to technology 11, wherein
the thin part is thinnest at a center in a width direction thereof and becomes gradually thinner from both ends thereof toward a vicinity of the center, and
a width of the thin part that is positioned at the boundary is larger than a width of another of the thin parts.

According to this technology, the pressure-receiving part in the vicinity of the boundary between the load sensors adjacent to each other can be made close to the boundary, and the load applied to this pressure-receiving part can be efficiently transmitted to the element part corresponding to this pressure-receiving part. Therefore, the dead space in the vicinity of this boundary can be further suppressed, and the load applied to the vicinity of this boundary can be more accurately detected.

### (Technology 13)

The load detecting device according to any one of technologies 1 to 12, wherein
at least one of the upper sealing member and the lower sealing member has electrical conductivity.

According to this technology, electromagnetic noise from outside can be blocked by the sealing member. Therefore, decrease in the load detection accuracy due to electromagnetic noise can be suppressed.

### (Technology 14)

The load detecting device according to technology 13, wherein
a member having electrical conductivity among the upper sealing member and the lower sealing member is electrically connected to a specific potential of the load sensor.

According to this technology, the effect of shielding electromagnetic noise can be enhanced. Therefore, decrease in the load detection accuracy due to electromagnetic noise can be further suppressed.

### (Technology 15)

The load detecting device according to any one of technologies 1 to 14, wherein
the load sensor is encapsulated in the sealing member such that the upper sealing member is in close contact with an upper face of the upper substrate.

According to this technology, in the upper sealing member, a difference can be caused, although slightly, in softness depending on the position. Therefore if displacement of the upper sealing member with respect to the upper substrate occurs, distribution of softness of the upper sealing member with respect to the upper substrate changes, and load detection sensitivity can vary in accordance with the region. Thus, there is a risk that the stability of load detection in the same region slightly decreases. In contrast, according to the above technology, displacement of the upper sealing member with respect to the upper substrate can be suppressed. Therefore, variation in the load detection sensitivity according to the region can be suppressed, and the load can be stably detected.

### (Technology 16)

The load detecting device according to any one of technologies 1 to 15, wherein
the lower sealing member has a higher rigidity than the upper sealing member.

According to this technology, the upper sealing member joined to the lower sealing member can be supported in a desired state by the lower sealing member. Accordingly, for example, the upper sealing member can appropriately maintain the state of being in close contact with the upper face of the upper substrate, and displacement of the upper sealing member with respect to the upper substrate can be suppressed. Therefore, the load can be stably detected. When the rigidity of the lower sealing member is relatively high, it is possible to prevent the load applied to the load detecting device from escaping to the surroundings via the lower substrate, and thus, the load can be appropriately detected. Further, since the shape in a plan view of the load detecting device is maintained, a situation where the upper substrate and the lower substrate are broken to be damaged can be avoided.

What is claimed is:

1. A load detecting device comprising:
a load sensor; and
a sealing member encapsulating the load sensor, wherein
the load sensor comprises
an upper substrate having elasticity,
a lower substrate disposed so as to oppose the upper substrate,
at least one electrically-conductive elastic body formed on at least one of an opposing face of the upper substrate and an opposing face of the lower substrate,
at least one linear electrically-conductive member disposed between the upper substrate and the lower substrate, and
a dielectric body formed on an outer periphery of the linear electrically-conductive member, and
the sealing member comprises
a lower sealing member on which the load sensor is placed,
an upper sealing member covering an upper face of the load sensor and joined to the lower sealing member, and
an air pressure adjustment structure configured to cause an air pressure in an accommodation space, of the load sensor, formed by the lower sealing member and the upper sealing member to be approximately equal to an outside air pressure.

2. The load detecting device according to claim 1, wherein
the air pressure adjustment structure includes a ventilation structure configured to cause the accommodation space to be ventilated to an outside.

3. The load detecting device according to claim 2, wherein
the ventilation structure includes a mesh structure configured to inhibit entry and exit of water and oil and configured to allow entry and exit of gas.

4. The load detecting device according to claim 3, wherein
the mesh structure is formed in the lower sealing member.

5. The load detecting device according to claim 2, wherein
the ventilation structure includes a ventilation hole formed on an outer side of the load sensor in a plan view.

6. The load detecting device according to claim 1, wherein
the air pressure adjustment structure includes a slack part whose capacity changes in accordance with a difference between the air pressure in the accommodation space and the outside air pressure.

7. The load detecting device according to claim 6, wherein
the slack part is formed in the upper sealing member.

8. The load detecting device according to claim 7, wherein
the slack part is configured to be more likely to be deformed than a portion, of the upper sealing member, where the slack part is not formed.

9. The load detecting device according to claim 6, wherein
the upper sealing member is affixed to an upper face of the upper substrate.

10. The load detecting device according to claim 1, wherein
a plurality of the load sensors are encapsulated in one said sealing member.

11. The load detecting device according to claim 10, wherein
in each of the load sensors, a plurality of the electrically-conductive elastic bodies and a plurality of the linear electrically-conductive members are disposed such that element parts for load detection formed by crossing of the electrically-conductive elastic bodies and the linear electrically-conductive members are arranged in a first direction and a second direction crossing the first direction in a plan view,
the plurality of load sensors are encapsulated in the sealing member so as to be adjacent to each other in the first direction,
the upper sealing member has: a plurality of pressure-receiving parts disposed at positions respectively corresponding to the plurality of element parts; and thin parts formed between the pressure-receiving parts adjacent to each other, and
the thin part that is positioned at a boundary between the load sensors adjacent to each other is formed so as to extend across the boundary.

12. The load detecting device according to claim 11, wherein
the thin part is thinnest at a center in a width direction thereof and becomes gradually thinner from both ends thereof toward a vicinity of the center, and
a width of the thin part that is positioned at the boundary is larger than a width of another of the thin parts.

13. The load detecting device according to claim 1, wherein
at least one of the upper sealing member and the lower sealing member has electrical conductivity.

14. The load detecting device according to claim 13, wherein
a member having electrical conductivity among the upper sealing member and the lower sealing member is electrically connected to a specific potential of the load sensor.

15. The load detecting device according to claim 1, wherein
the load sensor is encapsulated in the sealing member such that the upper sealing member is in close contact with an upper face of the upper substrate.

16. The load detecting device according to claim 1, wherein
the lower sealing member has a higher rigidity than the upper sealing member.
